(19) United States
(12) Patent Application Publication
(10) Pub. No.: US 2026/0236770 A1
(43) Pub. Date: Aug. 13, 2026

(54) DATA MATCHING METHOD AND MULTIMODAL MODEL PROCESSING METHOD

(71) Applicant: Tencent Technology (Shenzhen) Company Limited, Shenzhen (CN)

(72) Inventors: Xingwu SUN, Shenzhen (CN); Zhen YANG, Shenzhen (CN); Ruobing XIE, Shenzhen (CN); Fengzong LIAN, Shenzhen (CN); Zhanhui KANG, Shenzhen (CN); Chengzhong XU, Shenzhen (CN)

(73) Assignee: Tencent Technology (Shenzhen) Company Limited, Shenzhen, GD (CN)

(21) Appl. No.: 19/635,750

(22) Filed: Mar. 31, 2026

Related U.S. Application Data
(63) Continuation of application No. PCT/CN2024/127423, filed on Oct. 25, 2024.

(30) Foreign Application Priority Data
Dec. 21, 2023 (CN) 202311777194.1

(51) Int. Cl. G06N 3/08; G06F 16/583; G06N 3/045

(52) U.S. Cl. CPC G06N 3/08; G06F 16/583; G06N 3/045

(57) ABSTRACT

In a data matching method, first data of a first modality is encoded to obtain a first data representation, and second data of a second modality is encoded to obtain a second data representation. In the method, the first data representation and the second data representation are combined to obtain a hybrid data representation, and one or more fusion weights are determined based on the hybrid data representation. In the method, the first data representation and the hybrid data representation are fused based on the one or more fusion weights to obtain a first fused representation, and the second data representation and the hybrid data representation are fused based on the one or more fusion weights to obtain a second fused representation. In the method, a matching degree between the first data and the second data is determined based on the first fused representation and the second fused representation.

### RELATED APPLICATIONS

The present application is a continuation of International Application No. PCT/CN2024/127423, filed on Oct. 25, 2024, which claims priority to Chinese Patent Application No. 202311777194.1, entitled “DATA MATCHING METHOD AND APPARATUS, AND MULTIMODAL MODEL PROCESSING METHOD AND APPARATUS,” and filed on Dec. 21, 2023. The entire disclosures of the prior applications are hereby incorporated by reference.

### FIELD OF THE TECHNOLOGY

This disclosure relates to the technical field of computers, including a data matching method and apparatus, a computer device, a storage medium, and a computer program product, and including a multimodal model processing method and apparatus, a computer device, a storage medium, and a computer program product.

### BACKGROUND OF THE DISCLOSURE

With the development of computer technologies, machine learning technologies have emerged. Machine learning models are constructed through the machine learning technologies, and training the machine learning models enables them to have a task execution capability. In the field of vision-language learning, to improve the practicability of a model, a general vision-language pre-training (VLP) model may be pre-trained, and image-text processing may be performed through the VLP model.

In some applications, a VLP model typically adopts a structure of a dual encoder. The model has parallel encoders: one processes image data and the other processes text data. The performance of data processing using the VLP model may be further improved.

### SUMMARY

This disclosure provides a data matching method and apparatus, a computer device, a computer-readable storage medium, and a computer program product.

According to an aspect, this disclosure provides a data matching method. In the method, first data of a first modality is encoded to obtain a first data representation, and second data of a second modality is encoded to obtain a second data representation, the first modality and the second modality corresponding to different modalities. In the method, the first data representation and the second data representation are combined to obtain a hybrid data representation. In the method, one or more fusion weights are determined based on the hybrid data representation. In the method, the first data representation and the hybrid data representation are fused based on the one or more fusion weights to obtain a first fused representation, and the second data representation and the hybrid data representation are fused based on the one or more fusion weights to obtain a second fused representation. In the method, a matching degree between the first data and the second data is determined based on the first fused representation and the second fused representation.

According to an aspect, this disclosure provides a multimodal model processing method. In the method, a training sample pair is acquired, the training sample pair including first sample data of a first modality and second sample data of a second modality, and the first modality and the second modality corresponding to different modalities. In the method, at least a portion of the first sample data is encoded through an initial model to obtain a first sample data representation, and at least a portion of the second sample data is encoded through the initial model to obtain a second sample data representation. In the method, the first sample data representation and the second sample data representation are combined through the initial model to obtain a hybrid sample data representation. In the method, one or more prediction weights are determined based on the hybrid sample data representation. In the method, the first sample data representation and the hybrid sample data representation are fused based on the one or more prediction weights to obtain a first fused sample representation, and the first fused sample representation is decoded through the initial model to obtain a first predicted feature representation. In the method, the second sample data representation and the hybrid sample data representation are fused based on the one or more prediction weights to obtain a second fused sample representation, and the second fused sample representation is decoded through the initial model to obtain a second predicted feature representation. In the method, a first loss is determined based on a first benchmark feature representation of the first sample data and the first predicted feature representation of the first sample data, and a second benchmark feature representation of the second sample data and the second predicted feature representation of the second sample data. In the method, a second loss is determined based on an alignment label of the first sample data and the second sample data and the one or more prediction weights. In the method, a target loss function is constructed based on the first loss and the second loss. In the method, the initial model is updated based on the target loss function to obtain a trained multimodal model.

According to an aspect, this disclosure provides a data matching apparatus that includes processing circuitry. The processing circuitry is configured to encode first data of a first modality to obtain a first data representation, and encode second data of a second modality to obtain a second data representation, the first modality and the second modality corresponding to different modalities. The processing circuitry is configured to combine the first data representation and the second data representation to obtain a hybrid data representation. The processing circuitry is configured to determine one or more fusion weights based on the hybrid data representation. The processing circuitry is configured to fuse the first data representation and the hybrid data representation based on the one or more fusion weights to obtain a first fused representation, and to fuse the second data representation and the hybrid data representation based on the one or more fusion weights to obtain a second fused representation. The processing circuitry is configured to determine a matching degree between the first data and the second data based on the first fused representation and the second fused representation.

According to an aspect, this disclosure provides a multimodal model processing apparatus that includes processing circuitry. The processing circuitry is configured to acquire a training sample pair, the training sample pair including first sample data of a first modality and second sample data of a second modality, and the first modality and the second modality corresponding to different modalities. The processing circuitry is configured to encode at least a portion of the first sample data through an initial model to obtain a first sample data representation, and encode at least a portion of the second sample data through the initial model to obtain a second sample data representation. The processing circuitry is configured to combine the first sample data representation and the second sample data representation through the initial model to obtain a hybrid sample data representation. The processing circuitry is configured to determine one or more prediction weights based on the hybrid sample data representation. The processing circuitry is configured to fuse the first sample data representation and the hybrid sample data representation based on the one or more prediction weights to obtain a first fused sample representation, and decode the first fused sample representation through the initial model to obtain a first predicted feature representation. The processing circuitry is configured to fuse the second sample data representation and the hybrid sample data representation based on the one or more prediction weights to obtain a second fused sample representation, and decode the second fused sample representation through the initial model to obtain a second predicted feature representation. The processing circuitry is configured to determine a first loss based on a first benchmark feature representation of the first sample data and the first predicted feature representation of the first sample data, and a second benchmark feature representation of the second sample data and the second predicted feature representation of the second sample data. The processing circuitry is configured to determine a second loss based on an alignment label of the first sample data and the second sample data and the one or more prediction weights. The processing circuitry is configured to construct a target loss function based on the first loss and the second loss. The processing circuitry is configured to update the initial model based on the target loss function to obtain a trained multimodal model.

According to an aspect, this disclosure provides a non-transitory computer-readable storage medium storing instructions, which when executed by a processor, cause the processor to perform a data matching method. In the method, first data of a first modality is encoded to obtain a first data representation, and second data of a second modality is encoded to obtain a second data representation, the first modality and the second modality corresponding to different modalities. In the method, the first data representation and the second data representation are combined to obtain a hybrid data representation. In the method, one or more fusion weights are determined based on the hybrid data representation. In the method, the first data representation and the hybrid data representation are fused based on the one or more fusion weights to obtain a first fused representation, and the second data representation and the hybrid data representation are fused based on the one or more fusion weights to obtain a second fused representation. In the method, a matching degree between the first data and the second data is determined based on the first fused representation and the second fused representation.

According to an aspect, this disclosure provides a non-transitory computer-readable storage medium storing instructions, which when executed by a processor, cause the processor to perform a multimodal model processing method. In the method, a training sample pair is acquired, the training sample pair including first sample data of a first modality and second sample data of a second modality, and the first modality and the second modality corresponding to different modalities. In the method, at least a portion of the first sample data is encoded through an initial model to obtain a first sample data representation, and at least a portion of the second sample data is encoded through the initial model to obtain a second sample data representation. In the method, the first sample data representation and the second sample data representation are combined through the initial model to obtain a hybrid sample data representation. In the method, one or more prediction weights are determined based on the hybrid sample data representation. In the method, the first sample data representation and the hybrid sample data representation are fused based on the one or more prediction weights to obtain a first fused sample representation, and the first fused sample representation is decoded through the initial model to obtain a first predicted feature representation. In the method, the second sample data representation and the hybrid sample data representation are fused based on the one or more prediction weights to obtain a second fused sample representation, and the second fused sample representation are decoded through the initial model to obtain a second predicted feature representation. In the method, a first loss is determined based on a first benchmark feature representation of the first sample data and the first predicted feature representation of the first sample data, and a second benchmark feature representation of the second sample data and the second predicted feature representation of the second sample data. In the method, a second loss is determined based on an alignment label of the first sample data and the second sample data and the one or more prediction weights. In the method, a target loss function is constructed based on the first loss and the second loss. In the method, the initial model is updated based on the target loss function to obtain a trained multimodal model.

According to an aspect, this disclosure provides a data matching method, which is performed by a computer device, and includes: acquiring first data, and encoding the first data to obtain a first data representation; acquiring second data, and encoding the second data to obtain a second data representation, the first data and the second data being data of different modalities; combining the first data representation with the second data representation to obtain a hybrid data representation, and determining a fusion weight according to the hybrid data representation; fusing the first data representation and the hybrid data representation according to the fusion weight to obtain a first fused representation, and fusing the second data representation and the hybrid data representation according to the fusion weight to obtain a second fused representation; and determining a matching degree between the first data and the second data according to the first fused representation and the second fused representation.

According to another aspect, this disclosure further provides a data matching apparatus, including: an encoding module, configured to acquire first data, and encode the first data to obtain a first data representation; and acquire second data, and encode the second data to obtain a second data representation, the first data and the second data being data of different modalities; a determining module, configured to combine the first data representation with the second data representation to obtain a hybrid data representation, and determine a fusion weight according to the hybrid data representation; a fusion module, configured to fuse the first data representation and the hybrid data representation according to the fusion weight to obtain a first fused representation, and fuse the second data representation and the hybrid data representation according to the fusion weight to obtain a second fused representation; and a matching module, configured to determine a matching degree between the first data and the second data according to the first fused representation and the second fused representation.

According to another aspect, this disclosure provides a multimodal model processing method, which is performed by a computer device, and includes: acquiring a training sample pair, the training sample pair including first sample data and second sample data; and the first sample data and the second sample data being sample data of different modalities; encoding based on the first sample data through a to-be-trained initial model to obtain a first sample data representation; and encoding based on the second sample data to obtain a second sample data representation; combining the first sample data representation with the second sample data representation through the initial model to obtain a hybrid sample data representation, and determining a prediction weight according to the hybrid sample data representation; fusing the first sample data representation and the hybrid sample data representation according to the prediction weight through the initial model, and decoding based on a fused result to obtain a first predicted feature representation; fusing the second sample data representation and the hybrid sample data representation according to the prediction weight through the initial model, and decoding based on a fused result to obtain a second predicted feature representation; determining a first loss based on a real feature representation and the first predicted feature representation of the first sample data, and a real feature representation and the second predicted feature representation of the second sample data; determining a second loss based on an alignment label of the first sample data and the second sample data and the prediction weight; and constructing a target loss function according to the first loss and the second loss, and training the to-be-trained initial model based on the target loss function to obtain, after the training is completed, the multimodal model.

According to another aspect, this disclosure further provides a multimodal model processing apparatus, including: an encoding module, configured to acquire a training sample pair, the training sample pair including first sample data and second sample data; and the first sample data and the second sample data being sample data of different modalities; encode based on the first sample data through a to-be-trained initial model to obtain a first sample data representation; and encode based on the second sample data to obtain a second sample data representation; a determining module, configured to combine the first sample data representation with the second sample data representation through the initial model to obtain a hybrid sample data representation, and determine a prediction weight according to the hybrid sample data representation; a fusion module, configured to fuse the first sample data representation and the hybrid sample data representation according to the prediction weight through the initial model, and decode based on a fused result to obtain a first predicted feature representation; and the fusion module being further configured to fuse the second sample data representation and the hybrid sample data representation according to the prediction weight through the initial model, and decode based on a fused result to obtain a second predicted feature representation; a construction module, configured to determine a first loss based on a real feature representation and the first predicted feature representation of the first sample data, and a real feature representation and the second predicted feature representation of the second sample data; determine a second loss based on an alignment label of the first sample data and the second sample data and the prediction weight; and construct a target loss function according to the first loss and the second loss; and a training module, configured to train the to-be-trained initial model based on the target loss function to obtain, after the training is completed, the multimodal model.

According to another aspect, this disclosure further provides a computer device, including a memory (e.g., including a non-transitory computer-readable storage medium) and processing circuitry (e.g., a processor). The memory has a computer program stored therein, and the processor, when executing the computer program, implements operations of any of the foregoing methods.

According to another aspect, this disclosure further provides a non-transitory computer-readable storage medium, having a computer program stored therein, the computer program, when executed by processing circuitry (e.g., a processor), implementing operations of any of the foregoing methods.

According to another aspect, this disclosure further provides a computer program product, including a computer program which, when executed by processing circuitry (e.g., a processor), implements operations of any of the foregoing methods.

Details of one or more embodiments of this disclosure are provided in the accompanying drawings and descriptions below.

### BRIEF DESCRIPTION OF THE DRAWINGS

To illustrate technical solutions in embodiments of this disclosure, the drawings described in the descriptions are briefly introduced below. The drawings described below are only some embodiments of this disclosure, and a person skilled in the art may obtain other drawings according to these drawings.

FIG. 1 is a diagram of an disclosure environment of a data matching method and/or a multimodal model processing method according to an embodiment.

FIG. 2 is a schematic flowchart of a multimodal model processing method according to an embodiment.

FIG. 3 is a schematic diagram of a principle of masking according to an embodiment.

FIG. 4 is a schematic flowchart of a multimodal model processing method according to another embodiment.

FIG. 5 is a schematic flowchart of a data matching method according to an embodiment.

FIG. 6 is a schematic flowchart of a data matching method according to another embodiment.

FIG. 7 is a structural block diagram of a multimodal model according to an embodiment.

FIG. 8 is a structural block diagram of a data matching apparatus according to an embodiment.

FIG. 9 is a structural block diagram of a multimodal model processing apparatus according to an embodiment.

FIG. 10 is a diagram of an internal structure of a computer device according to an embodiment.

### DESCRIPTION OF EMBODIMENTS

Technical solutions in embodiments of this disclosure will be described below with reference to the accompanying drawings. The described embodiments are merely some rather than all of the embodiments of this disclosure. Other embodiments obtained by a person skilled in the art based on the embodiments of this disclosure fall within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

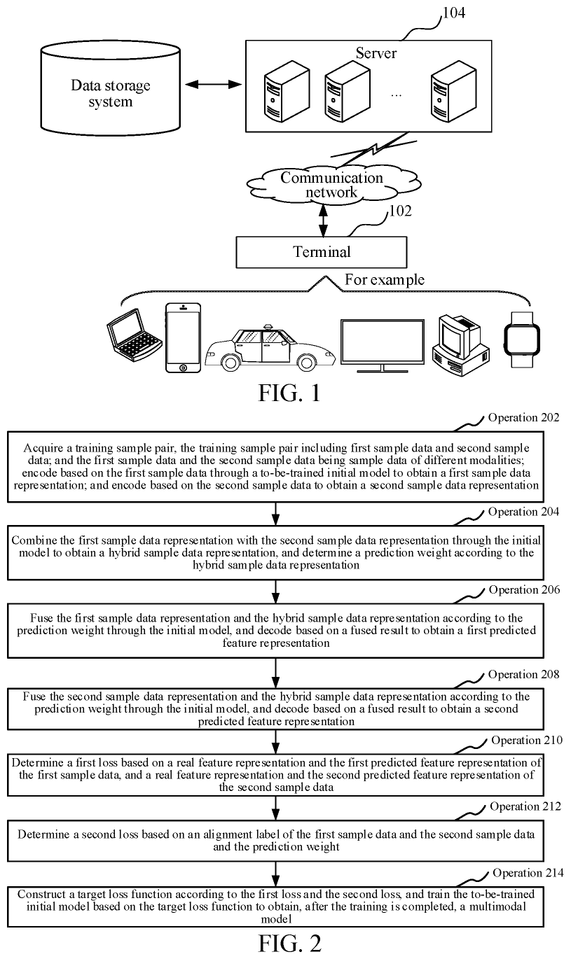

The data matching method and/or the multimodal model processing method provided in the embodiments of this disclosure may be applied to an application environment shown in FIG. 1. A terminal 102 communicates with a server 104 through a network. A data storage system may store data that needs to be processed by the server 104. The data storage system may be integrated onto the server 104, or may be placed on a cloud or another network server. The terminal and the server may each independently perform the data matching method and/or the multimodal model processing method provided in the embodiments of this disclosure, or may cooperatively perform the data matching method and/or the multimodal model processing method provided in the embodiments of this disclosure. An example in which the server independently performs the data matching method provided in this disclosure is used for description. The server receives first data and second data that are transmitted by the terminal, encodes the first data to obtain a first data representation, and encodes the second data to obtain a second data representation, the first data and the second data being data of different modalities; combines the first data representation with the second data representation to obtain a hybrid data representation, and determines a fusion weight according to the hybrid data representation: fuses the first data representation and the hybrid data representation according to the fusion weight to obtain a first fused representation, and fuses the second data representation and the hybrid data representation according to the fusion weight to obtain a second fused representation; and determines a matching degree between the first data and the second data according to the first fused representation and the second fused representation. The server feeds back the matching degree to the terminal.

The terminal 102 may be, but is not limited to, various personal computers, a notebook computer, a smartphone, a tablet computer, an Internet of Things device, and a portable wearable device. The Internet of Things device may be a smart speaker, a smart television, a smart air conditioner, a smart in-vehicle device, or the like. The portable wearable device may be a smart watch, a smart bracelet, a head-mounted device, or the like. The server 104 may be an independent physical server, may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal may be a smartphone, a tablet computer, a notebook computer, a desktop computer, a smart speaker, a smart watch, or the like, but is not limited thereto. The terminal and the server may be directly or indirectly connected in a wired or wireless communication manner. This is not limited in this disclosure.

The multimodal model mentioned in the embodiments of this disclosure may be a pre-training model (PTM). The PTM, alternatively referred to as a foundation model or a large model, refers to a deep neural network (DNN) with a large number of parameters. The PTM is trained on a massive amount of unlabeled data. A function approximation capability of the DNN with a large number of parameters enables the PTM to extract common features from the data. The PTM is applicable to downstream tasks through technologies such as fine-tuning, parameter-efficient fine-tuning (PEFT), and prompt-tuning. Therefore, the PTM may achieve an ideal effect in a few-shot scene or a zero-shot scene. The PTMs may be classified into language models (embeddings from language models (ELMO), bidirectional encoder representation from transformer (BERT), generative pre-trained transformer (GPT)), vision models (swin-transformer, vision transformer (ViT), vision mixture-of-experts (V-MOE)), voice models (VALL-E), multimodal models (vision BERT (ViBERT), contrastive language-image pre-training (CLIP), Flamingo, Gato), and the like according to processed data modalities. The multimodal model refers to a model in which two or more data modality feature representations are established. The PTM is an important tool for outputting artificial intelligence generated content (AIGC), and may further be used as a general interface for connecting multiple specific task models.

Solutions provided in the embodiments of this disclosure relate to artificial intelligence technologies such as machine learning and large models, and are described through the following embodiments.

Before the data matching method and/or the multimodal model processing method provided in this disclosure are described, some abbreviations and terms used in this disclosure are introduced below as non-limiting examples:
VLP: vision-language pre-training.
GIAE: gated interactive masked autoencoder.
GIM: gated interactive mechanism.
MAE: masked autoencoder.
Transformer: this term may correspond to a neural network architecture based on an attention mechanism, may effectively encode temporal information in an encoder part, and may be widely applied to fields such as natural language processing, computer vision, machine translation, and voice recognition.
LightVLP: a lightweight vision-language pre-training framework, which may correspond to a lightweight VLP model framework. In some examples, the multimodal model described in this disclosure is a LightVLP.

In the field of vision-language learning, to improve the practicability of a model, a general VLP model may be typically pre-trained, and image-text processing is performed through the VLP model. In addition, in a business processing process as a non-limiting example, to adapt to diversified downstream tasks, training may be performed based on the VLP model to obtain a task model applicable to a specific business scene. Therefore, how to obtain a high-performance VLP model through training is an item of very practical value.

A VLP method may face the following challenges: (1) a training procedure is very time-consuming because text and an image are usually inputted for a long time; (2) embedded information of different modalities is not effectively fused; and (3) in the real world, much image-text alignment training data has significant noise, and needs to be further processed.

In view of this, this disclosure proposes a multimodal model processing method, which may resolve the foregoing technical problems, and optimizes a multimodal information fusion manner based on improving the efficiency of the VLP model, to obtain a better effect. In addition, in a training process, the multimodal model of this disclosure can further better deal with the modality data mismatching in a training data set, such as image-text mismatching, thereby improving the processing performance of the model.

A method for training a multimodal model involved in this disclosure is first introduced below.

In an embodiment, as shown in FIG. 2, a multimodal model processing method is provided. An example in which the method is applied to a computer device (for example, the terminal or the server in FIG. 1) is used for description. The method includes the following operation 202 to operation 214.

Operation 202: Acquire a training sample pair, the training sample pair including first sample data and second sample data; and the first sample data and the second sample data being sample data of different modalities; encode based on the first sample data through a to-be-trained initial model to obtain a first sample data representation; and encode based on the second sample data to obtain a second sample data representation. For example, first data of a first modality is encoded to obtain a first data representation, and second data of a second modality is encoded to obtain a second data representation. The first modality and the second modality correspond to different modalities.

The initial model is a pre-constructed neural network model, and then becomes a multimodal model after training is completed. The initial model in this disclosure may include two encoders having a symmetric relationship, two decoders having a symmetric relationship, and cross transformer structures configured to process interaction information.

The training sample pair is a pre-constructed data pair configured for model training. The training sample pair includes the first sample data and the second sample data. The first sample data is data of a first modality, the second sample data is data of a second modality, and the first modality is different from the second modality. The modality is a manner of carrying information using a perception channel, such as visual, auditory, olfactory, or tactile. The modality in this disclosure may be at least one of a visual modality, a text modality, or an audio modality. For example, the first sample data may be image data, and the second sample data may be text data. Alternatively, the first sample data may be image data, and the second sample data may be audio data. This is not limited in this disclosure.

For ease of understanding, data used and generated in a model training stage are distinguished from data used and generated in a model application stage, the word “sample” is included in related data names, for example, first sample data and second sample data.

The terms “first”, “second”, and the like used in this disclosure may be used herein for describing various elements, but these elements are not limited by these terms. These terms are merely used for distinguishing a first element from another element. For example, without departing from the scope of this disclosure, the first sample data may be referred to as the second sample data, and similarly, first data may be referred to as second data.

Encoding is a process of mapping plaintext information to hidden space through operations. In this disclosure, encoding may be performed based on the first sample data through a first encoder in the to-be-trained initial model to obtain the first sample data representation. Encoding is performed based on the second sample data through a second encoder in the initial model to obtain the second sample data representation.

In some embodiments, the computer device may directly encode the first sample data to obtain the first sample data representation, and directly encode the second sample data to obtain the second sample data representation. In other embodiments, the computer device may mask the first sample data, and then encode masked first sample data through the first encoder in the initial model to obtain the first sample data representation. The computer device may mask the second sample data, and then encode masked second sample data through the second encoder in the initial model to obtain the second sample data representation.

For ease of description, data inputted to the first encoder may be referred to as a first input sequence, and data inputted to the second encoder may be referred to as a second input sequence. That is, the first input sequence may be the first sample data, or may be the masked first sample data. The second input sequence may be the second sample data, or may be the masked second sample data.

In some embodiments, the to-be-trained initial model encodes the first input sequence multiple times to obtain the first sample data representation. The to-be-trained initial model encodes the second input sequence multiple times to obtain the second sample data representation.

In some embodiments, the first encoder and the second encoder have a same network structure. Therefore, the manner for encoding the first input sequence is the same as the manner for encoding the second input sequence. Certainly, in another embodiment, the first encoder and the second encoder may have different network structures. The manner for encoding the first input sequence is different from the manner for encoding the second input sequence. This is not limited in this disclosure.

An example in which the first encoder and the second encoder have the same network structure is used for description. For any encoding, for example, (l+1)^{th} encoding, output of l^{th} encoding may be acquired first. According to the output of the l^{th} encoding, a multi-head self-attention layer operation is performed. A multi-head self-attention layer operation result is combined with the output of the l^{th} encoding, and then a layer normalization operation is performed to obtain intermediate processing features in the encoding process. Feedforward neural network processing is performed on the intermediate processing features in the encoding process. A feedforward neural network processing result is combined with the intermediate processing features in the encoding process, and then a layer normalization operation is performed to obtain output of the (l+1)^{th} encoding. l+1 is used as new l, and the operation of acquiring output of l^{th} encoding is returned to continue execution until the last encoding is completed. The output of the last encoding is used as the first sample data representation or the second sample data representation. l is a natural number greater than or equal to 0. When l is 0, the acquired output of the l^{th} encoding is the first input sequence or the second input sequence.

In some embodiments, the computer device may encode each piece of input data (when the first input sequence includes multiple data blocks, each piece of input data is each data block) in the first input sequence multiple times to obtain output corresponding to each piece of input data, and then concatenate output corresponding to each piece of input data in the last encoding to obtain the first sample data representation. Similarly, the computer device may encode each piece of input data in the second input sequence multiple times to obtain output corresponding to each piece of input data, and then concatenate output corresponding to each piece of input data in the last encoding to obtain the second sample data representation.

Illustratively, the computer device may represent the output of the (l+1)^{th} encoding corresponding to any input data through formula 1:

$${H}^{l + 1} = {f}_{LN} ( {f}_{LN} ( {H}^{l} + {f}_{SA}^{l} ( {H}^{l} ) ) + {f}_{FF}^{l} ( {f}_{LN} ( {H}^{l} + {f}_{SA}^{l} ( {H}^{l} ) ) ) ) , \qquad ( Formula 1 )$$

where H^{l} represents the output of the l^{th} encoding, and may alternatively be considered as hidden features of an l^{th} layer; f_{LN} represents a layer normalization operation,

$${f}_{SA}^{l}$$

represents a multi-head self-attention layer operation performed through a network of the l^{th} layer of the encoder,

$${f}_{FF}^{l}$$

represents feedforward neural network (which may be a two-layer fully connected network) processing through the l^{th} layer of the encoder;

$${f}_{LN} ( {H}^{l} + {f}_{SA}^{l} ( {H}^{l} ) )$$

is the intermediate processing features in the encoding process. The encoder may be the first encoder or the second encoder. H^{l+1} represents the output of the (l+1)^{th} encoding, and may alternatively be considered as hidden features of an (l+1)^{th} layer.

Further, the computer device may represent the first sample data representation through the following formula 2:

$${H}_{x}^{{l}_{e}} = {H}_{{x}_{1}}^{{l}_{e}} , {H}_{{x}_{2}}^{{l}_{e}} , … , {H}_{{x}_{M}}^{{l}_{e}} , \qquad ( Formula 2 )$$

where x₁ represents a first data block in the first input sequence, x₂ represents a second data block in the first input sequence, and x_{M} represents an M^{th} data block (that is, the last data block) in the first input sequence;

$${H}_{{x}_{1}}^{{l}_{e}}$$

represents maden features that are outputted by the last encoding layer of the first encoder and that correspond to the first data block,

$${H}_{{x}_{2}}^{{l}_{e}}$$

represents hidden features that are outputted by the last encoding layer of the first encoder and that correspond to the second data block,

$${H}_{{x}_{M}}^{{l}_{e}}$$

represents hidden features that are outputted by the last encoding layer of the first encoder and that correspond to the M^{th} data block, and

$${H}_{x}^{{l}_{e}}$$

represents the first sample data representation.

Further, the computer device may represent the second sample data representation through the following formula 3:

$${H}_{w}^{{l}_{e}} = {H}_{{w}_{1}}^{{l}_{e}} , {H}_{{w}_{2}}^{{l}_{e}} , … , {H}_{{w}_{N}}^{{l}_{e}} , \qquad ( Formula 3 )$$

where w₁ represents a first data block in the second input sequence, w₂ represents a second data block in the second input sequence, and w_{N} represents an N^{th} data block (that is, the last data block) in the second input sequence;

$${H}_{{w}_{1}}^{{l}_{e}}$$

represents hidden features that are outputted by the last encoding layer of the second encoder and that correspond to the first data block,

$${H}_{{w}_{2}}^{{l}_{e}}$$

represents hidden features that are outputted by the last encoding layer of the second encoder and that correspond to the second data block,

$${H}_{{w}_{N}}^{{l}_{e}}$$

represents hidden features that are outputted by the last encoding layer of the second encoder and that correspond to the N^{th} data block, and

$${H}_{w}^{{l}_{e}}$$

represents the second sample data representation.

In some embodiments, the first encoder and/or the second encoder includes a recurrent neural network, a convolutional neural network, or a graph neural network. In some examples, more or fewer network layers may be designed according to implementation requirements. This is not limited in this disclosure. In some embodiments, the first encoder and/or the second encoder may have a transformer structure.

Operation 204: Combine the first sample data representation with the second sample data representation through the initial model to obtain a hybrid sample data representation, and determine a prediction weight according to the hybrid sample data representation. For example, the first data representation and the second data representation are combined to obtain a hybrid data representation. In some examples, one or more fusion weights are determined by processing circuitry based on the hybrid data representation.

When the alignment quality of first sample data and second sample data in a training sample pair is relatively high, information of a hybrid modality may be more considered during single-modality decoding. When the first sample data and the second sample data have relatively large noise (for example, image-text mismatching), information of the single modality may be more considered during single-modality decoding. Based on this consideration, a GIM is designed in this disclosure to control a ratio of a single data representation to a hybrid data representation to be referred to during decoding, that is, dynamically adjust a reference ratio through a fusion weight. The fusion weight may be referred to as a gating weight.

In at least one embodiment, the initial model may fuse the first sample data representation and the second sample data representation through a cross transformer structure to obtain a hybrid sample data representation, and then perform numerical conversion on the hybrid-modality sample representation to obtain the prediction weight.

In some embodiments, the computer device may directly perform an addition or multiplication operation on the first sample data representation and a second sample modality to obtain the hybrid sample data representation. In other embodiments, the computer device may further perform an attention operation on the first sample data representation and the second sample data representation to obtain the hybrid sample data representation. In another embodiment, the computer device may further adopt more complex operations, for example, perform attention mechanism processing, then perform matrix addition or multiplication, and then perform linear/nonlinear transformation, to obtain the hybrid sample data representation. A specific fusion manner is not limited in this disclosure.

Further, after combining the first sample data representation with the second sample data representation to obtain the hybrid sample data representation, the initial model may perform linear transformation on the hybrid sample data representation followed by activation, to obtain the prediction weight. That is, the hybrid sample data representation may be converted into a value, and the value is the prediction weight. In some examples, the one or more fusion weights are obtained based on performing linear transformation on the hybrid data representation followed by an activation processing (e.g., using an activation function).

Operation 206: Fuse the first sample data representation and the hybrid sample data representation according to the prediction weight through the initial model, and decode based on a fused result to obtain a first predicted feature representation. In some examples, the first data representation and the hybrid data representation are fused based on the one or more fusion weights to obtain a first fused representation.

In at least one embodiment, the initial model may weight the first sample data representation and the hybrid sample data representation according to the prediction weight, and decode based on a weighted result to obtain the first predicted feature representation.

In some embodiments, the computer device may use the prediction weight as a weight of either of the first sample data representation and the hybrid sample data representation, and perform weighted summation on the first sample data representation and the hybrid sample data representation.

In some embodiments, the computer device may use the prediction weight as a weight of either of the first sample data representation and the hybrid sample data representation, use a difference between a value 1 and the prediction weight as a weight of the other representation, and perform weighted summation on the first sample data representation and the hybrid sample data representation.

In some embodiments, the fusing the first sample data representation and the hybrid sample data representation according to the prediction weight includes: using the prediction weight as a coefficient of the hybrid sample data representation, and using a difference between the value 1 and the prediction weight as a coefficient of the first sample data representation; and weighting the hybrid sample data representation and the first sample data representation according to the coefficient of the hybrid sample data representation and the coefficient of the first sample data representation to obtain a first fused sample representation.

In at least one embodiment, the initial model may perform weighted summation on the hybrid sample data representation and the first sample data representation according to the coefficient of the hybrid sample data representation and the coefficient of the first sample data representation to obtain the first fused sample representation. Illustratively, the computer device may calculate the first fused sample representation through the following formula 4:

$${O}_{1} = ( 1 - p ) * {H}_{x}^{{l}_{e}} + p * S , \qquad ( Formula 4 )$$

where p is the prediction weight,

$${H}_{x}^{{l}_{e}}$$

is the first sample data representation, S is the hybrid sample data representation, and O₁ is the first fused sample representation.

In the foregoing embodiment, by fusing the hybrid sample data representation and the first sample data representation according to the prediction weight, the ratio of the single data representation to the hybrid data representation may be flexibly referred to according to the alignment quality of data of two modalities, so that the fused representation may better express information of the single-modality data.

Further, the initial model may decode based on the first fused sample representation to obtain the first predicted feature representation.

In some embodiments, the initial model encodes masked first sample data, and in the process of masking the first sample data, some data blocks are selectively discarded in various manners. Therefore, during decoding, a mask embedding may be inserted into the first fused sample representation according to a position of the discarded data block in the first sample data. The mask embedding may be a preset feature representation, for example, a feature representation including preset values (the preset value is, for example, 0 or 1). Further, the first decoder in the initial model may decode the first fused sample representation in which the mask embedding is inserted, to obtain the first predicted feature representation. The first predicted feature representation represents hidden features of the discarded data block.

Operation 208: Fuse the second sample data representation and the hybrid sample data representation according to the prediction weight through the initial model, and decode based on a fused result to obtain a second predicted feature representation. In some examples, the second data representation and the hybrid data representation are fused based on the one or more fusion weights to obtain a second fused representation.

In at least one embodiment, the initial model may weight the second sample data representation and the hybrid sample data representation according to the prediction weight, and decode based on a weighted result to obtain the second predicted feature representation.

In some embodiments, the computer device may use the prediction weight as a weight of either of the second sample data representation and the hybrid sample data representation, and perform weighted summation on the second sample data representation and the hybrid sample data representation.

In some embodiments, the computer device may use the prediction weight as a weight of either of the second sample data representation and the hybrid sample data representation, use a difference between a value 1 and the prediction weight as a weight of the other representation, and perform weighted summation on the second sample data representation and the hybrid sample data representation.

In some embodiments, the fusing the second sample data representation and the hybrid sample data representation according to the prediction weight includes: using the prediction weight as the coefficient of the hybrid sample data representation, and using the difference between the value 1 and the prediction weight as a coefficient of the second sample data representation; and weighting the hybrid sample data representation and the second sample data representation according to the coefficient of the hybrid sample data representation and the coefficient of the second sample data representation to obtain a second fused sample representation.

In at least one embodiment, the initial model may perform weighted summation on the hybrid sample data representation and the second sample data representation according to the coefficient of the hybrid sample data representation and the coefficient of the second sample data representation to obtain the second fused sample representation. Illustratively, the computer device may calculate the second fused sample representation through the following formula 5:

$${O}_{2} = ( 1 - p ) * {H}_{w}^{{l}_{e}} + p * S , \qquad ( Formula 5 )$$

where p is the prediction weight,

$${H}_{w}^{{l}_{e}}$$

is the second sample data representation, S is the hybrid sample data representation, and O₂ is the second fused sample representation.

In the foregoing embodiment, by fusing the hybrid sample data representation and the second sample data representation according to the prediction weight, the ratio of the single data representation to the hybrid data representation may be flexibly referred to according to the alignment quality of data of two modalities, so that the fused representation may better express information of the single-modality data.

Further, the initial model may decode based on the second fused sample representation to obtain the second predicted feature representation.

In some embodiments, the initial model encodes masked second sample data, and in the process of masking the second sample data, some data blocks are selectively discarded in various manners. Therefore, during decoding, a mask embedding may be inserted into the second fused sample representation according to a position of the discarded data block in the second sample data. The mask embedding may be a preset feature representation, for example, a feature representation including preset values (the preset value is, for example, 0 or 1). Further, the second decoder in the initial model may decode the second fused sample representation in which the mask embedding is inserted, to obtain the second predicted feature representation. The second predicted feature representation represents hidden features of the discarded data block.

Operation 210: Determine a first loss based on a real feature representation and the first predicted feature representation of the first sample data, and a real feature representation and the second predicted feature representation of the second sample data.

In at least one embodiment, the computer device may extract the real feature representation of the first sample data to calculate a difference between the real feature representation and the first predicted feature representation of the first sample data, and use the difference as a first modality loss. The computer device may extract the real feature representation of the second sample data to calculate a difference between the real feature representation and the second predicted feature representation of the second sample data, and use the difference as a second modality loss. The first loss is determined according to the first modality loss and the second modality loss. The difference may be represented through a difference value, a comparison value, a quotient, or the like.

In some embodiments, the real feature representation of the first sample data participating in the loss calculation may be a real feature representation of some data blocks discarded from the first sample data before encoding. The real feature representation of the second sample data participating in the loss calculation may be a real feature representation of some data blocks discarded from the second sample data before encoding.

In other embodiments, the real feature representation of the first sample data participating in the loss calculation may alternatively be a real feature representation of all data blocks in the first sample data. The real feature representation of the second sample data participating in the loss calculation may alternatively be a real feature representation of all data blocks in the second sample data.

In some embodiments, the computer device may extract the real feature representation of the first sample data and the real feature representation of the second sample data through another trained codec.

In some embodiments, when the first sample data is image data, the difference between the real feature representation and the first predicted feature representation of the first sample data may be measured through a mean square error (MSE) loss. When the second sample data is text data, the difference between the real feature representation and the second predicted feature representation of the second sample data may be measured through a cross-entropy (CE) loss.

In some embodiments, the computer device may use an average value of differences between real feature representations and first predicted feature representations of multiple pieces of first sample data as the first modality loss, and use an average value of differences between real feature representations and second predicted feature representations of multiple pieces of second sample data as the second modality loss.

Illustratively, the computer device may calculate the first modality loss through the following formula:

$${L}_{MIR} = \frac{1}{\vert {M}_{x} \vert} {\sum }_{m ∈ {M}_{x}} {f}_{M S E} ( {x}_{m} , {x}_{m}^{′} ) , \qquad ( Formula 6 )$$

where Mₓ represents a set formed by first sample data in a training sample set, |Mₓ| is a quantity of first sample data in the set formed by the first sample data, f_{MSE} represents an MSE function, xₘ represents a first predicted feature representation of an m^{th} piece of first sample data,

$${x}_{m}^{′}$$

represents a real feature representation of the m^{th} piece of first sample data, and L_{MIR} is the first modality loss.

Illustratively, the computer device may calculate the second modality loss through the following formula:

$${L}_{M T R} = \frac{1}{\vert {M}_{w} \vert} {\sum }_{m ∈ {M}_{w}} {f}_{C E} ( {y}_{m} , {y}_{m}^{′} ) , \qquad ( Formula 7 )$$

where M_{w} represents a set formed by second sample data in the training sample set, |M_{w}| is a quantity of second sample data in the set formed by the second sample data, f_{CE} represents a CE function, yₘ represents a second predicted feature representation of an m^{th} piece of second sample data,

$${y}_{m}^{′}$$

represents a real feature representation of the mt^{h} piece of second sample data, and L_{MTR} is the second modality loss.

In some embodiments, the computer device may use a sum of the first modality loss and the second modality loss as the first loss, use an average value of the first modality loss and the second modality loss as the first loss, or use a product of the first modality loss and the second modality loss as the first loss. This is not limited in this disclosure.

Operation 212: Determine a second loss based on an alignment label of the first sample data and the second sample data and the prediction weight.

The alignment label is a label representing whether the first sample data and the second sample data are aligned, and the alignment of the first sample data and the second sample data represents that content of the first sample data and content of the second sample data match. If the first sample data and the second sample data are not aligned, the content of the first sample data and the content of the second sample data do not match. An example in which the first sample data is the image data and the second sample data is the text data is used. Alignment indicates that the image and text are consistent, and misalignment indicates that the image and text are inconsistent.

When the first sample data and the second sample data are aligned data, the content of the first sample data and the content of the second sample data match. Therefore, during decoding, more references may be made to the hybrid sample data representation, that is, a ratio of the hybrid sample data representation is controlled to be larger.

In some embodiments, the computer device may set the alignment label to 1 or 0, where 1 represents alignment, and 0 represents misalignment. Further, the second loss is determined based on a difference between the alignment label and the prediction weight. For example, the second weight may be determined based on a difference between the alignment label and the prediction weight.

In some embodiments, the determining a second loss based on an alignment label of the first sample data and the second sample data and the prediction weight includes: constructing a first vector based on the alignment label of the first sample data and the second sample data; constructing a second vector according to the prediction weight and a difference between a value 1 and the prediction weight; and determining a second loss according to the first vector and the second vector.

In at least one embodiment, the computer device may construct the first vector based on the alignment label of the first sample data and the second sample data. In at least one embodiment, a value of the alignment label and a difference between 1 and the value may be used as a two-dimensional vector, that is, the first vector. For example, when the alignment label is 1, a constructed first vector is [0, 1]. When the alignment label is 0, a constructed first vector is [1, 0].

The computer device may construct the second vector using the prediction weight and the difference between the value 1 and the prediction weight, for example, [1−p, p], where p is the prediction weight.

Further, the computer device may determine the second loss according to the CE of the first vector and the second vector. Illustratively, the computer device may determine the second loss through the following formula:

$${L}_{ITM} = {f}_{C E} ( {y}_{itm} , [ 1 - p , p ] ) \qquad ( Formula 8 )$$

where yᵢₜₘ represents the first vector, p is the prediction weight, f_{CE} represents the CE function, and L_{ITM} represents the second loss.

In the foregoing embodiment, the second loss is determined based on the alignment label of the first sample data and the second sample data and the prediction weight, so that the prediction weight learned by the model through training is in positive correlation with an alignment degree of the input data. That is, when the alignment quality of the input data is higher, the prediction weight is larger, and the ratio of the hybrid data representation may be dynamically controlled to increase.

Operation 214: Construct a target loss function according to the first loss and the second loss, and train the to-be-trained initial model based on the target loss function to obtain, after the training is completed, the multimodal model.

In at least one embodiment, the computer device may perform weighted summation on the first loss and the second loss to construct the target loss function. A weighting coefficient may be 1, or may be another preset value. This is not limited in this disclosure.

Illustratively, the computer device may construct the target loss function through the following formula:

$$L = {L}_{MIR} + {L}_{M T R} + {L}_{ITM} , \qquad ( Formula 9 )$$

where L_{MIR} represents the first modality loss in the first loss, L_{MTR} represents the second modality loss in the first loss, L_{ITM} represents the second loss, and L represents the target loss function.

Further, the computer device may input multiple training sample pairs to the initial model in batches for processing, and adjust a model weight of the initial model through the target loss function to train the initial model. The training stops when a training stopping condition is reached, to obtain a trained multimodal model. The training stopping condition may be that a preset number of iterations is reached, a preset training duration is reached, model performance reaches preset performance, a change of predicted precision of the model is less than a preset change, or the like. This is not limited in this disclosure.

According to the foregoing multimodal model processing method, the first sample data and the second sample data that belong to different modalities are separately encoded, to obtain the first sample data representation and the second sample data representation. Further, the first sample data representation is combined with the second sample data representation to obtain the hybrid sample data representation, and the prediction weight may be obtained according to the hybrid sample data representation. The prediction weight is configured for controlling ratios of the first sample data representation and the second sample data representation to be separately fused with the hybrid sample data representation, that is, information may be intelligently extracted from a single modality/a hybrid modality for subsequent decoding. During training, the loss between the predicted feature representation and the real feature representation is considered, and a matching loss (that is, the second loss) between sample data of different modalities is considered. This enables the model to learn an encoding/decoding capability closer to the real feature representation, while intelligently controlling a ratio of the single data representation to the hybrid data representation to be referred to in the encoding/decoding process. Therefore, when the alignment quality of the training sample pair is relatively high, information of the hybrid modality may be more considered during decoding of a single modality. When the training sample pair is not aligned, information of the single modality may be more considered during decoding of the single modality, so that the problem of mismatching of modality content in the training data set can be better processed, and the processing performance of the multimodal model can be improved.

In some embodiments, before the encoding based on first sample data and second sample data in a training sample pair, the method further includes: acquiring the training sample pair, the training sample pair including the first sample data and the second sample data; splitting the first sample data to obtain multiple first data blocks, and splitting the second sample data to obtain multiple second data blocks; and extracting some data blocks of the multiple first data blocks to form a first input sequence, and extracting some data blocks of the multiple second data blocks to form a second input sequence. The encoding based on first sample data and second sample data in a training sample pair to obtain a first sample data representation and a second sample data representation includes: encoding the first input sequence multiple times to obtain the first sample data representation, and encoding the second input sequence multiple times to obtain the second sample data representation.

In at least one embodiment, the computer device may perform model training on the initial model through the training sample pair. In the training process, the computer device may directly process the first sample data and the second sample data in the training sample pair, or may first mask the first sample data and the second sample data and then input the first sample data and the second sample data to the initial model.

In some embodiments, the computer device may split the first sample data to obtain multiple first data blocks, and split the second sample data to obtain multiple second data blocks. Further, some data blocks of the multiple first data blocks are extracted according to a particular ratio to form the first input sequence, and some data blocks of the multiple second data blocks are extracted to form the second input sequence. The first input sequence is inputted to one encoder of the initial model, and the second input sequence is inputted to another encoder of the initial model.

In some embodiments, for the multiple first data blocks of the first sample data, the computer device may randomly mask a particular ratio of the first data blocks, and form the first input sequence using the remaining first data blocks. For the multiple second data blocks of the second sample data, the computer device may randomly mask a particular ratio of the second data blocks, and form the second input sequence using the remaining second data blocks.

Illustratively, the initial model uses two separate autoencoders to model different modality information. For one modality, for example, image data, the computer device may randomly mask a particular ratio (for example, 50%) of patches, and then the remaining patches form an input sequence. The input sequence is inputted to an autoencoder corresponding to the image data to obtain an image representation.

In some embodiments, an example in which the first modality is an image modality and the second modality is a text modality is used for description. In some examples, a multimodal model of this disclosure may correspond to a LightVLP model and contains two autoencoders, which process image information and text information, respectively. To improve the efficiency of the model, a masking autoencoder policy is introduced in this disclosure. Sequences obtained after sample data of two modalities is masked have their masked tokens (masked features) removed and then inputted to respective autoencoders.

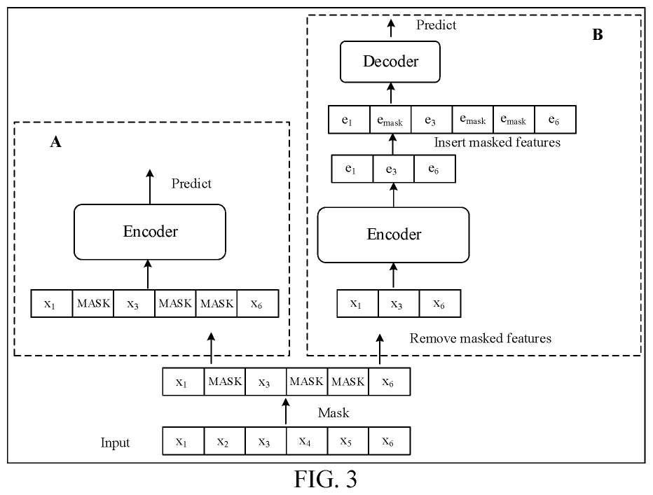

For ease of understanding, FIG. 3 is a schematic diagram of a masking policy according to an embodiment. Using sample data (x₁, x₂, x₃, x₄, x₅, x₆) as an example, in some masking policy examples, referring to part A in FIG. 3, some data blocks, such as x₂, x₄, and x₅, are usually randomly masked and transformed into masked features, such as by replacing them with 0 or 1. Further, a sequence including the masked features is inputted as an input sequence to the encoder for processing. The masking policy in this disclosure is as follows. Referring to part B in FIG. 3, some data blocks, such as x₂, x₄, and x₅, are randomly masked and transformed into masked features, such as by replacing them with 0 or 1. Further, a sequence from which the masked features are removed is inputted as an input sequence to the encoder for processing. Further, after the input sequence is encoded through the encoder, a corresponding data representation (e₁, e₃, e₆) is obtained. Then, the masked features are inserted into the data representation for decoding. In the foregoing embodiment, during processing of data of different modalities, a masking-based encoding policy is introduced. For data of each modality, some data blocks are extracted to form an input sequence, so that a data volume of the model in the encoding process may be greatly reduced, and the processing efficiency of the model may be improved. Particularly in the training stage, the training efficiency of the model may be effectively improved.

In some embodiments, the combining the first sample data representation with the second sample data representation through the initial model to obtain a hybrid sample data representation includes: performing multiple interactive fusions on the first sample data representation and the second sample data representation through the initial model to obtain a first hybrid sample representation biased toward a first modality and a second hybrid sample representation biased toward a second modality; and combining the first hybrid sample representation with the second hybrid sample representation to obtain the hybrid sample data representation.

In at least one embodiment, in the process of fusing the first sample data representation and the second sample data representation by the initial model, multiple fusions may be performed through multiple layers of neural networks to obtain the first hybrid sample representation biased toward the first modality and the second hybrid sample representation biased toward the second modality. In at least one embodiment, for each interactive fusion, the second intermediate hybrid sample representation may be fused into the first intermediate hybrid sample representation based on an attention mechanism to obtain the first intermediate hybrid sample representation biased toward the first modality. The first intermediate hybrid sample representation is fused into the second intermediate hybrid sample representation based on the attention mechanism to obtain the second intermediate hybrid sample representation biased toward the second modality. In this way, a first intermediate hybrid sample representation outputted by the last layer of the neural network is the first hybrid sample representation, and a second intermediate hybrid sample representation outputted by the last layer of the neural network is the second hybrid sample representation.

Further, the initial model may fuse the first hybrid sample representation and the second hybrid sample representation to obtain the hybrid sample data representation. For example, fusion is performed through weighted summation, contacting, concatenating, or the like. This is not limited in this disclosure.

In the foregoing embodiment, multiple interactive fusions are performed on the first sample data representation and the second sample data representation through the initial model to obtain the first hybrid sample representation biased toward the first modality and the second hybrid sample representation biased toward the second modality. Relationship information between the first sample data and the second sample data may be fully extracted, and then the first hybrid sample representation is combined with the second hybrid sample representation to obtain the hybrid sample data representation.

In some embodiments, the performing multiple interactive fusions on the first sample data representation and the second sample data representation through the initial model to obtain a first hybrid sample representation biased toward a first modality and a second hybrid sample representation biased toward a second modality includes: acquiring, when performing an (i+1)^{th} interactive fusion, a first intermediate hybrid sample representation and a second intermediate hybrid sample representation that are outputted by an i^{th} interactive fusion; fusing the second intermediate hybrid sample representation into the first intermediate hybrid sample representation to obtain a first intermediate hybrid sample representation of the (i+1)^{th} interactive fusion; fusing the first intermediate hybrid sample representation into the second intermediate hybrid sample representation to obtain a second intermediate hybrid sample representation of the (i+1)^{th} interactive fusion; using i+1 as new i, and returning to the operation of acquiring, when performing an (i+1)^{th} interactive fusion, a first intermediate hybrid sample representation and a second intermediate hybrid sample representation that are outputted by an i^{th} interactive fusion to continue execution until a stopping condition is satisfied; and using a first intermediate hybrid sample representation outputted by a last interactive fusion as the first hybrid sample representation, and using a second intermediate hybrid sample representation outputted by the last interactive fusion as the second hybrid sample representation, i being a natural number greater than or equal to 0; and when i is 0, an acquired first intermediate hybrid sample representation outputted by the i^{th} interactive fusion being the first sample data representation, and an acquired second intermediate hybrid sample representation outputted by the i^{th} interactive fusion being the second sample data representation.

In some examples, the multiple interactive fusions is performed based on performing an (i+1)^{th} interactive fusion. In some examples, in the (i+1)^{th} interactive fusion, a first intermediate hybrid representation of an i^{th} interactive fusion and a second intermediate hybrid representation the an i^{th} interactive fusion are obtained. In some examples, in the (i+1)th interactive fusion, the second intermediate hybrid representation of the i^{th} interactive fusion is fused into the first intermediate hybrid representation of the i^{th} interactive fusion to obtain a first intermediate hybrid representation of the (i+1)^{th} interactive fusion, and the first intermediate hybrid representation of the i^{th} interactive fusion is fused into the second intermediate hybrid representation of the i^{th} interactive fusion to obtain a second intermediate hybrid representation of the (i+1)^{th} interactive fusion. In some examples, in the (i+1)^{th} interactive fusion, when a stopping condition is satisfied, the first intermediate hybrid representation of the (i+1)^{th} interactive fusion is output as the first hybrid representation, and the second intermediate hybrid representation of the (i+1)^{th} interactive fusion is output as the second hybrid representation. In some examples, i is an integer greater than or equal to 0. In some examples, when i is 0, the first intermediate hybrid representation of the i^{th} interactive fusion corresponds to the first data representation, and the second intermediate hybrid representation of the i^{th} interactive fusion corresponds to the second data representation.

In at least one embodiment, for the first interactive fusion, the initial model may fuse the second sample data representation into the first sample data representation based on the attention mechanism to obtain a first intermediate hybrid sample representation, and fuse the first sample data representation into the second sample data representation based on the attention mechanism to obtain a second intermediate hybrid sample representation.

For the second interactive fusion, the initial model may fuse the second intermediate hybrid sample representation obtained through the first interactive fusion into the first intermediate hybrid sample representation based on the attention mechanism to obtain a new first intermediate hybrid sample representation. The first intermediate hybrid sample representation obtained through the first interactive fusion is fused into the second intermediate hybrid sample representation based on the attention mechanism to obtain a new second intermediate hybrid sample representation.

In this way, in each interactive fusion process, a current interactive fusion is continuously performed according to output of previous interactive fusion until the last interactive fusion. The initial model may directly output a first intermediate hybrid sample representation and a second intermediate hybrid sample representation obtained through the last interactive fusion. The currently outputted first intermediate hybrid sample representation is the first hybrid sample representation, and the currently outputted second intermediate hybrid sample representation is the second hybrid sample representation.

In the foregoing embodiment, after the first sample data representation and the second sample data representation are fused, the next interactive fusion is continuously performed based on the previous output through the iterative loop, so that information obtained from each fusion may be better utilized, ensuring more sufficient information fusion.

In some embodiments, the fusing the second intermediate hybrid sample representation into the first intermediate hybrid sample representation to obtain a first intermediate hybrid sample representation of the (i+1)^{th} interactive fusion includes: performing an attention operation according to the first intermediate hybrid sample representation and the second intermediate hybrid sample representation that are outputted by the i^{th} interactive fusion, combining an attention operation result with the first intermediate hybrid sample representation outputted by the i^{th} interactive fusion, and then performing a layer normalization operation to obtain first intermediate sample processing features; and performing feedforward neural network processing on the first intermediate sample processing features, combining a feedforward neural network processing result with the first intermediate sample processing features, and then performing a layer normalization operation to obtain the first intermediate hybrid sample representation of the (i+1)^{th} interactive fusion.

In at least one embodiment, when the layer normalization operation is performed after the attention operation result is combined with the first intermediate hybrid sample representation outputted by the i^{th} interactive fusion, a combination manner of the attention operation result and the first intermediate hybrid sample representation outputted by the i^{th} interactive fusion may be addition, multiplication, concatenation, or the like. This is not limited in this disclosure. When the layer normalization operation is performed after the feedforward neural network processing result is combined with the first intermediate sample processing features, a combination manner of the feedforward neural network processing result and the first intermediate sample processing features may be addition, multiplication, concatenation, or the like. This is not limited in this disclosure.

Illustratively, the computer device may determine the first intermediate hybrid sample representation of the (i+1)^{th} interactive fusion through the following formula:

$${S}_{x}^{i + 1} = ( {f}_{LN} ( {f}_{LN} ( {S}_{x}^{i} + {f}_{CROSS}^{i} ( {S}_{x}^{i} \vert {S}_{w}^{i} ) ) + {f}_{FF}^{i} ( {f}_{LN} ( {S}_{x}^{i} + {f}_{CROSS}^{i} ( {S}_{x}^{i} \vert {S}_{w}^{i} ) ) ) ) , \qquad ( Formula 10 )$$

$${f}_{CROSS}^{i} ( {S}_{x}^{i} \vert {S}_{w}^{i} ) = softmax ( {Q}_{x} * {K}_{w} / \sqrt{{d}_{k}} ) {V}_{w} , \qquad ( Formula 11 )$$

where

$${S}_{x}^{i}$$

is the first intermediate hybrid sample representation obtained through the i^{th} interactive fusion,

$${S}_{w}^{i}$$

is the second intermediate hybrid sample representation obtained through the i^{th} interactive fusion,

$${f}_{CROSS}^{i} ( {S}_{x}^{i} \vert {S}_{w}^{i} )$$

is a classic attention calculation formula and represents attention processing with

$${S}_{x}^{i}$$

as a Q value and

$${S}_{w}^{i}$$

as K and V values, and softmax is a normalization function.

$${S}_{x}^{i + 1}$$

is the first intermediate hybrid sample representation obtained through the (i+1)^{th} interactive fusion. f_{LN} represents a layer normalization operation, and

$${f}_{F F}^{i}$$

represents feedforward neural network (which may be a two-layer fully connected network) processing through the i^{th} layer of the cross transformer structure.

In the foregoing embodiment, in the interactive fusion manner based on the attention mechanism, the second intermediate hybrid sample representation may be better fused into the first intermediate hybrid sample representation. In addition, through such a stacked fusion design, gradient explosion may be prevented during model training.

In some embodiments, the fusing the first intermediate hybrid sample representation into the second intermediate hybrid sample representation to obtain a second intermediate hybrid sample representation of the (i+1)^{th} interactive fusion includes: performing an attention operation according to the second intermediate hybrid sample representation and the first intermediate hybrid sample representation that are outputted by the i^{th} interactive fusion, combining an attention operation result with the second intermediate hybrid sample representation outputted by the i^{th} interactive fusion, and then performing a layer normalization operation to obtain second intermediate sample processing features; and performing feedforward neural network processing on the second intermediate sample processing features, combining a feedforward neural network processing result with the second intermediate sample processing features, and then performing a layer normalization operation to obtain the second intermediate hybrid sample representation of the (i+1)^{th} interactive fusion.

In at least one embodiment, when the layer normalization operation is performed after the attention operation result is combined with the second intermediate hybrid sample representation outputted by the i^{th} interactive fusion, a combination manner of the attention operation result and the second intermediate hybrid sample representation outputted by the i^{th} interactive fusion may be addition, multiplication, concatenation, or the like. This is not limited in this disclosure. When the layer normalization operation is performed after the feedforward neural network processing result is combined with the second intermediate sample processing features, a combination manner of the feedforward neural network processing result and the second intermediate sample processing features may be addition, multiplication, concatenation, or the like. This is not limited in this disclosure.

Illustratively, the computer device may determine the second intermediate hybrid sample representation of the (i+1)^{th} interactive fusion through the following formula:

$${S}_{w}^{i + 1} = ( {f}_{LN} ( {f}_{LN} ( {S}_{w}^{i} + {f}_{CROSS}^{i} ( {S}_{w}^{i} \vert {S}_{x}^{i} ) ) + {f}_{FF}^{i} ( {f}_{LN} ( {S}_{w}^{i} + {f}_{CROSS}^{i} ( {S}_{w}^{i} \vert {S}_{x}^{i} ) ) ) ) , \qquad ( Formula 12 )$$

$${f}_{CROSS}^{i} ( {S}_{w}^{i} \vert {S}_{x}^{i} ) = softmax ( {Q}_{w} * {K}_{x} / \sqrt{{d}_{k}} ) {V}_{x} , \qquad ( Formula 13 )$$

where

$${S}_{x}^{i}$$

is the first intermediate hybrid sample representation obtained through the i^{th} interactive fusion,

$${S}_{w}^{i}$$

is the second intermediate hybrid sample representation obtained through the i^{th} interactive fusion,

$${f}_{CROSS}^{i} ( {S}_{w}^{i} \vert {S}_{x}^{i} )$$

is a classic attention calculation formula and represents attention processing with

$${S}_{w}^{i}$$

as a Q value and

$${S}_{x}^{i}$$

as K and V values, and softmax is a normalization function.

$${S}_{w}^{i + 1}$$

is the second intermediate hybrid sample representation of the (i+1)^{th} interactive fusion. f_{LN} represents a layer normalization operation, and

$${f}_{FF}^{i}$$

represents feedforward neural network (which may be a two-layer fully connected network) processing through the i^{th} layer of the cross transformer structure.

In the foregoing embodiment, in the interactive fusion manner based on the attention mechanism, the first intermediate hybrid sample representation may be better fused into the second intermediate hybrid sample representation. In addition, through such a stacked fusion design, gradient explosion may be prevented during model training.

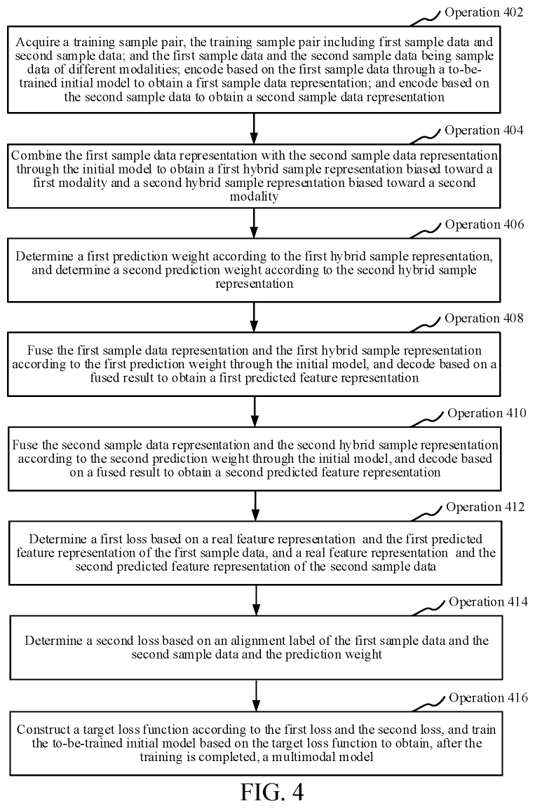

In some embodiments, referring to FIG. 4, the multimodal model processing method includes the following operations.

Operation 402: Acquire a training sample pair, the training sample pair including first sample data and second sample data; and the first sample data and the second sample data being sample data of different modalities; encode based on the first sample data through a to-be-trained initial model to obtain a first sample data representation; and encode based on the second sample data to obtain a second sample data representation. For example, a training sample pair includes first sample data of a first modality and second sample data of a second modality, and the first modality and the second modality corresponding to different modalities. In some examples, at least a portion of the first sample data is encoded through an initial model to obtain a first sample data representation, and at least a portion of the second sample data is encoded through the initial model to obtain a second sample data representation.

Operation 404: Combine the first sample data representation with the second sample data representation through the initial model to obtain a first hybrid sample representation biased toward a first modality and a second hybrid sample representation biased toward a second modality. In some examples, the first sample data representation and the second sample data representation are combined through the initial model to obtain a hybrid sample data representation.

In at least one embodiment, multiple interactive fusions are performed on the first sample data representation and the second sample data representation through the initial model to obtain the first hybrid sample representation biased toward the first modality and the second hybrid sample representation biased toward the second modality. A specific manner for performing multiple interactive fusions may refer to descriptions of the foregoing related embodiments.

Operation 406: Determine a first prediction weight according to the first hybrid sample representation, and determine a second prediction weight according to the second hybrid sample representation. In some examples, one or more prediction weights are determined based on the hybrid sample data representation.

In some embodiments, the initial model may perform linear transformation on the first hybrid sample representation followed by activation to obtain the first prediction weight; and perform linear transformation on the second hybrid sample representation followed by activation to obtain the second prediction weight. In some examples, the one or more fusion weights are obtained based on performing linear transformation on the hybrid data representation followed by an activation processing (e.g., using an activation function).

Operation 408: Fuse the first sample data representation and the first hybrid sample representation according to the first prediction weight through the initial model, and decode based on a fused result to obtain a first predicted feature representation. In some examples, the first sample data representation and the hybrid sample data representation are fused based on the one or more prediction weights to obtain a first fused sample representation. In some examples, the first fused sample representation is decoded through the initial model to obtain a first predicted feature representation.

In at least one embodiment, the initial model may use the first prediction weight as a coefficient of the first hybrid sample representation, and use a difference between a value 1 and the first prediction weight as a coefficient of the first sample data representation; and perform weighted summation on the first hybrid sample representation and the first sample data representation according to the coefficient of the first hybrid sample representation and the coefficient of the first sample data representation, and then decode based on a result of the weighted summation to obtain the first predicted feature representation.

Operation 410: Fuse the second sample data representation and the second hybrid sample representation according to the second prediction weight through the initial model, and decode based on a fused result to obtain a second predicted feature representation. In some examples, the second sample data representation and the hybrid sample data representation are fused based on the one or more prediction weights to obtain a second fused sample representation. In some examples, the second fused sample representation is decoded through the initial model to obtain a second predicted feature representation.

In at least one embodiment, the initial model may use the second prediction weight as a coefficient of the second hybrid sample representation, and use a difference between the value 1 and the second prediction weight as a coefficient of the second sample data representation; and perform weighted summation on the second hybrid sample representation and the second sample data representation according to the coefficient of the second hybrid sample representation and the coefficient of the second sample data representation, and then decode based on a result of the weighted summation to obtain the second predicted feature representation.

Operation 412: Determine a first loss based on a real feature representation and the first predicted feature representation of the first sample data, and a real feature representation and the second predicted feature representation of the second sample data. In some examples, a first loss is determined based on a first benchmark feature representation of the first sample data and the first predicted feature representation of the first sample data, and a second benchmark feature representation of the second sample data and the second predicted feature representation of the second sample data.

Operation 414: Determine a second loss based on an alignment label of the first sample data and the second sample data and the prediction weight. In some examples, a second loss is determined based on an alignment label of the first sample data and the second sample data and the one or more prediction weights.

Operation 416: Construct a target loss function according to the first loss and the second loss, and train the to-be-trained initial model based on the target loss function to obtain, after the training is completed, the multimodal model. In some examples, a target loss function is constructed based on the first loss and the second loss. In some examples, the initial model is updated based on the target loss function to obtain a trained multimodal model.

In the foregoing embodiment, for the first modality, the initial model may use a first sample modality as main information, fuse information of the second sample data representation to obtain the first hybrid sample representation, and then determine the prediction weight of the first modality, that is, the first prediction weight, according to the first hybrid sample representation. In this way, the ratio of single-modality information to hybrid-modality information to be referred to during decoding of the first modality may be subsequently controlled according to the first prediction weight. For the second modality, the initial model may use a second sample modality as main information, fuse information of the first sample data representation to obtain the second hybrid sample representation, and then determine the prediction weight of the second modality, that is, the second prediction weight, according to the second hybrid sample representation. In this way, the ratio of the single-modality information to the hybrid-modality information to be referred to during decoding of the second modality may be subsequently controlled according to the second prediction weight. In this way, different modalities may be more flexible and adaptive when fusing the hybrid-modality information.

In some embodiments, the hybrid sample data representation includes the first hybrid sample representation biased toward the first modality and the second hybrid sample representation biased toward the second modality, and the prediction weight includes a first prediction weight determined according to the first hybrid sample representation and a second prediction weight determined according to the second hybrid sample representation. The determining a second loss based on an alignment label of the first sample data and the second sample data and the prediction weight includes: constructing a first vector based on the alignment label of the first sample data and the second sample data; determining a target weight according to an average value of the first prediction weight and the second prediction weight, and constructing a second vector based on the target weight and a difference between the value 1 and the target weight; and determining the second loss according to the first vector and the second vector.

In some examples, the method may further include splitting the first sample data into multiple first data blocks and splitting the second sample data into multiple second data blocks. In some examples, a first input sequence is formed based on an un-masked portion of the first data blocks, and a second input sequence is formed based on an un-masked portion of the second data blocks. In some examples, the encoding the at least the portion of the first sample data includes encoding the first input sequence to obtain the first sample data representation. In some examples, the encoding the at least the portion of the second sample data includes encoding the second input sequence to obtain the second sample data representation.

Previously, for different modalities, the initial model may generate predicted losses adapted to the modalities. In the model training process, an average value of a first predicted loss and a second predicted loss may be used as a target loss, and then the second loss is determined according to the target loss and the alignment label.

In at least one embodiment, the computer device may construct the first vector based on the alignment label of the first sample data and the second sample data. In at least one embodiment, a value of the alignment label and a difference between 1 and the value may be used as a two-dimensional vector, that is, the first vector. For example, when the alignment label is 1, a constructed first vector is [0, 1]. When the alignment label is 0, a constructed first vector is [1, 0].

The computer device may construct the second vector using the target weight and the difference between the value 1 and the target weight, for example, [1−p, p], where p is the target weight. Further, the computer device may determine the second loss according to the CE of the first vector and the second vector. In some examples, a second vector is constructed based on one or more prediction weights and a difference between a value 1 and a weight value based on the one or more prediction weights (e.g., an average thereof).

In the foregoing embodiment, the second loss is determined based on the alignment label of the first sample data and the second sample data and the average value of the first prediction weight and the second prediction weight, so that two prediction weights learned by the model through training are in positive correlation with the alignment degree of the input data. That is, when the alignment quality of the input data is higher, the two prediction weights are larger, and the ratio of the hybrid data representation may be dynamically controlled to increase.

In some embodiments, the method further includes constructing a third loss. The operation of constructing a third loss includes: determining a correlation between the first sample data and the second sample data according to the first sample data representation and the second sample data representation; and determining a third loss based on the alignment label of the first sample data and the second sample data and the correlation between the first sample data and the second sample data. The constructing a target loss function according to the first loss and the second loss includes: constructing the target loss function according to the first loss, the second loss, and the third loss.

In some embodiments, to align representations of different modalities, this disclosure introduces a comparison loss, that is, the third loss. The third loss is added to the target loss for learning, so that the model may compensate for the performance impact caused by data misalignment of the training sample pair in the training process.

In at least one embodiment, the computer device may acquire the first sample data representation outputted by a first encoder and the second sample data representation outputted by a second encoder. Further, the first sample data representation is inputted to a linear layer and a normalization layer to obtain a first conversion representation, and the second sample data representation is inputted to the linear layer and the normalization layer to obtain a second conversion representation.

Illustratively, the computer device may calculate the first conversion representation through the following formula:

$${T}_{1} = {f}_{NORM} ( {f}_{x} ( {H}_{x}^{{l}_{e}} ) ) , \qquad ( Formula 14 )$$

where f_{NORM} represents normalization, fₓ represents linearization,

$${H}_{x}^{{l}_{e}}$$

represents the first sample data representation, and T₁ represents the first conversion representation.

Illustratively, the computer device may calculate the second conversion representation through the following formula:

$${T}_{2} = {f}_{NORM} ( {f}_{w} ( {H}_{w}^{{l}_{e}} ) ) , \qquad ( Formula 15 )$$

where f_{NORM} represents normalization, f_{w} represents linearization,

$${H}_{w}^{{l}_{e}}$$

represents the second sample data representation, and T₂ represents the second conversion representation.

Further, the computer device may determine the correlation between the first sample data and the second sample data according to the first conversion representation and the second conversion representation. For example, a similarity between the first conversion representation and the second conversion representation may be calculated and then used as the correlation between the first sample data and the second sample data. The similarity may be a cosine similarity, a distance similarity, or the like. This is not limited in this disclosure.

Next, the computer device may determine the third loss based on a difference between the alignment label of the first sample data and the second sample data and the correlation between the first sample data and the second sample data. In at least one embodiment, a CE between the alignment label and the correlation may be calculated and then used as the third loss.

Further, the computer device may construct the target loss function according to the first loss, the second loss, and the third loss, for example, perform summation on the first loss, the second loss, and the third loss to construct the target loss function. Illustratively, the computer device may construct the target loss function through the following formula:

$$L = {L}_{MIR} + {L}_{MTR} + {L}_{ITM} + {L}_{ITC} , \qquad ( Formula 16 )$$

where L_{MIR} represents the first modality loss in the first loss, L_{MTR} represents the second modality loss in the first loss, L_{ITM} represents the second loss, L_{ITC} represents the third loss, and L represents the target loss function.

In the foregoing embodiment, in the model training process, a comparison loss is introduced to guide the model to learn a capability of distinguishing whether representations of different modalities are aligned.

In some embodiments, the correlation between the first sample data and the second sample data includes a correlation of the first sample data with respect to the second sample data and a correlation of the second sample data with respect to the first sample data. The determining a correlation between the first sample data and the second sample data according to the first sample data representation and the second sample data representation includes: determining a preset quantity of pieces of third sample data having a same modality as the first sample data, and a preset quantity of pieces of fourth sample data having a same modality as the second sample data; calculating the correlation of the first sample data with respect to the second sample data according to the first sample data representation, the second sample data representation, and sample data representations of the fourth sample data; and calculating the correlation of the second sample data with respect to the first sample data according to the first sample data representation, the second sample data representation, and sample data representations of the third sample data.

When the correlation between the first sample data and the second sample data is calculated, the correlation of the first sample data with respect to the second sample data and the correlation of the second sample data with respect to the first sample data may be separately calculated.

In at least one embodiment, the computer device performs linear processing and normalization on the first sample data representation to obtain a first conversion representation, and performs linear processing and normalization on the second sample data representation to obtain a second conversion representation. The computer device performs linear processing and normalization on the third sample data representation to obtain third conversion representations, and performs linear processing and normalization on the fourth sample data representation to obtain fourth conversion representations.

Further, the computer device may calculate the correlation of the first sample data with respect to the second sample data according to the first conversion representation, the second conversion representation, and each fourth conversion representation; and calculate the correlation of the second sample data with respect to the first sample data according to the first conversion representation, the second conversion representation, and each third conversion representation.

In some embodiments, the calculating the correlation of the first sample data with respect to the second sample data according to the first sample data representation, the second sample data representation, and sample data representations of the fourth sample data includes: determining a first value according to the first sample data representation and the second sample data representation; determining multiple second values according to the first sample data representation and the sample data representations of the fourth sample data; and using a comparison value between the first value and a sum of the multiple second values as the correlation of the first sample data with respect to the second sample data.

In at least one embodiment, the computer device may determine the first value according to a product of the first conversion representation and the second conversion representation. For example, the product is directly used as the first value, or a quotient of the product and a temperature coefficient is used as an exponent, or a result of an exponentiation with the natural constant e as a base is used as the first value. Similarly, the computer device may determine the second value according to a product of the first conversion representation and each fourth conversion representation. Further, the computer device uses the comparison value between the first value and a sum of the multiple second values as the correlation of the first sample data with respect to the second sample data. The comparison value may be a value that can reflect a difference, such as a quotient or a difference.

Illustratively, the computer device may calculate the correlation of the first sample data with respect to the second sample data through the following formula:

$${p}_{g}^{i 2 t} ( I ) = \frac{exp ( I * {T}_{g}^{′} / k )}{{\sum }_{j = 1}^{Mc} exp ( I * {T}_{j}^{′} / k )} , \qquad ( Formula 17 )$$

where

$${p}_{g}^{i 2 t} ( I )$$

represents the correlation of the first sample data with respect to the second sample data; I represents the first conversion representation of the first sample data in the current training sample pair, and

$${T}_{g}^{′}$$

represents the second conversion representation of the second sample data corresponding to the first sample data in the current training sample pair; M_{c} is the preset quantity, and

$${T}_{j}^{′}$$

represents a fourth conversion representation of a j^{th} piece of fourth sample data; k represents the temperature coefficient.

In the foregoing embodiment, when the correlation of the first sample data with respect to the second sample data is calculated, the fourth sample data having different content but the same modality as the second sample data is used, so that the alignment degree between the sample data pair and another data pair formed by the first sample data may be calculated. Therefore, the correlation of the first sample data with respect to the second sample data may be accurately obtained.

In some embodiments, the calculating the correlation of the second sample data with respect to the first sample data according to the first sample data representation, the second sample data representation, and sample data representations of the third sample data includes: determining a first value according to the first sample data representation and the second sample data representation; determining multiple third values according to the second sample data representation and the sample data representations of the third sample data; and using a comparison value between the first value and a sum of the multiple third values as the correlation of the second sample data with respect to the first sample data.

In at least one embodiment, the computer device may determine the first value according to a product of the first conversion representation and the second conversion representation. For example, the product is directly used as the first value, or a quotient of the product and a temperature coefficient is used as an exponent, or a result of an exponentiation with a natural constant e as a base is used as the first value. Similarly, the computer device may determine the third value according to a product of the second conversion representation and each third conversion representation. Further, the computer device uses the comparison value between the first value and a sum of the multiple third values as the correlation of the second sample data with respect to the first sample data. The comparison value may be a value that can reflect a difference, such as a quotient or a difference.

Illustratively, the computer device may calculate the correlation of the second sample data with respect to the first sample data through the following formula:

$${p}_{g}^{t 2 i} ( T ) = \frac{exp ( T * {I}_{g}^{′} / k )}{{\sum }_{j = 1}^{Mc} exp ( T * {I}_{j}^{′} / k )} , \qquad ( Formula 18 )$$

where

$${p}_{g}^{t 2 i} ( T )$$

represents the correlation of the second sample data with respect to the first sample data; T represents the second conversion representation of the second sample data in the current training sample pair, and

$${I}_{g}^{′}$$

represents the first conversion representation of the first sample data corresponding to the second sample data in the current training sample pair; M_{c} is the preset quantity, and

$${I}_{j}^{′}$$

represents a third conversion representation of a j^{th} piece of third sample data; k represents the temperature coefficient.

In the foregoing embodiment, when the correlation of the second sample data with respect to the first sample data is calculated, the third sample data having different content but the same modality as the first sample data is used, so that the alignment degree between the sample data pair and another data pair formed by the second sample data may be calculated. Therefore, the correlation of the second sample data with respect to the first sample data may be accurately obtained.

Further, the computer device may determine one loss based on a difference between the alignment label of the first sample data and the second sample data and the correlation of the first sample data with respect to the second sample data, determine another loss according to a difference between the alignment label and the correlation of the second sample data with respect to the first sample data, and then average the two losses to obtain the third loss.

Illustratively, the computer device may calculate the third loss through the following formula:

$${L}_{ITC} = \frac{1}{2} {f}_{CE} ( {y}^{i 2 t} ( I ) , {p}^{i 2 t} ( I ) ) + \frac{1}{2} {f}_{CE} ( {y}^{t 2 i} ( T ) , {p}^{t 2 i} ( T ) ) , \qquad ( Formula 19 )$$

where, for a training sample pair, y^{i2t}(I) and y^{t2i}(T) are the same, representing the alignment label of the first sample data and the second sample data in the training sample pair. p^{i2t}(I) represents the correlation of the first sample data with respect to the second sample data, and p^{t2i}(T) represents the correlation of the second sample data with respect to the first sample data. f_{CE} is a CE loss function. L_{ITC} represents the third loss.

In the foregoing embodiment, the correlation of the first sample data with respect to the second sample data may be accurately calculated using the fourth sample data having different content but the same modality as the second sample data. The correlation of the second sample data with respect to the first sample data may be accurately obtained using the third sample data having different content but the same modality as the first sample data. Thus, a two-dimensional correlation is obtained, so that an alignment degree between representations of two modalities processed by the encoder in the multimodal model may be more accurately measured.

In some embodiments, the modality includes an image modality and a text modality. The method further includes a text retrieval operation, including: acquiring a text retrieval task, extracting specified image data in the text retrieval task, and forming to-be-processed first data pairs using text data in a text library and the specified image data; processing the first data pair through the multimodal model to obtain two feature representations, and determining a matching degree of the first data pair based on the two feature representations; and determining, according to matching degrees of the first data pairs, target text matching the specified image data.

The multimodal model trained according to the foregoing embodiment may be applied to an image-text retrieval scene, for example, may be configured to retrieve text matching an image. In some examples, if the text retrieval task is acquired, the computer device may extract the specified image data in the text retrieval task, and then form multiple first data pairs using the text data in the text library and the specified image data. Therefore, any first data pair is processed through the trained multimodal model, and two feature representations corresponding to the first data pair are outputted. Therefore, the computer device may determine the matching degree of the first data pair based on the two feature representations, use, according to the matching degrees of the first data pairs, the text data in the first data whose matching degree satisfies a push condition as the target text matching the specified image data, and push the target text to the terminal for presentation, that is, a text retrieval result of the specified image data is obtained. The matching degree satisfying the push condition may refer to the highest matching degree, the matching degree exceeding a preset threshold, the top N highest matching degrees, or the like. This is not limited in this disclosure.

In some embodiments, a specific manner for determining the matching degree of the first data pair may be any one of the following manners: calculating a feature similarity of two feature representations, and using the feature similarity as the matching degree; and inputting two feature representations to a classification layer, outputting a classification result through the classification layer, and using a classification result as the matching degree. The feature similarity may be represented through a cosine similarity, a Euclidean distance, a Manhattan distance, or the like.

In the foregoing embodiment, matching calculation of the image and the text may be realized through the trained multimodal model, thereby helping improve the text retrieval quality and efficiency.

In some embodiments, the modality includes an image and text. The method further includes an image retrieval operation, including: acquiring an image retrieval task, extracting specified text data in the image retrieval task, and forming to-be-processed second data pairs using image data in an image library and the specified text data; processing the second data pair through the multimodal model to obtain two feature representations, and determining a matching degree of the second data pair based on the two feature representations; and determining, according to matching degrees of the second data pairs, a target image matching the specified text data.

The multimodal model trained according to the foregoing embodiment may be applied to an image-text retrieval scene, for example, may be configured to retrieve an image matching text. In some examples, if the image retrieval task is acquired, the computer device may extract the specified text data in the image retrieval task, and then form multiple second data pairs using the image data in the image library and the specified text data. Therefore, any second data pair is processed through the trained multimodal model, and two feature representations corresponding to the second data pair are outputted. Therefore, the computer device may determine the matching degree of the second data pair based on the two feature representations, use, according to the matching degrees of the second data pairs, the image data in the second data whose matching degree satisfies the push condition as the target image matching the specified text data, and push the target image to the terminal for presentation, that is, an image retrieval result of the specified text data is obtained. The matching degree satisfying the push condition may refer to the highest matching degree, the matching degree exceeding a preset threshold, the top N highest matching degrees, or the like. This is not limited in this disclosure.

In some embodiments, a specific manner for determining the matching degree of the second data pair may be any one of the following manners: calculating a feature similarity of two feature representations, and using the feature similarity as the matching degree; and inputting two feature representations to the classification layer, outputting a classification result through the classification layer, and using a classification result as the matching degree. The feature similarity may be represented through a cosine similarity, a Euclidean distance, a Manhattan distance, or the like.

In the foregoing embodiment, matching calculation of the image and the text may be realized through the trained multimodal model, thereby helping improve the image retrieval quality and efficiency.

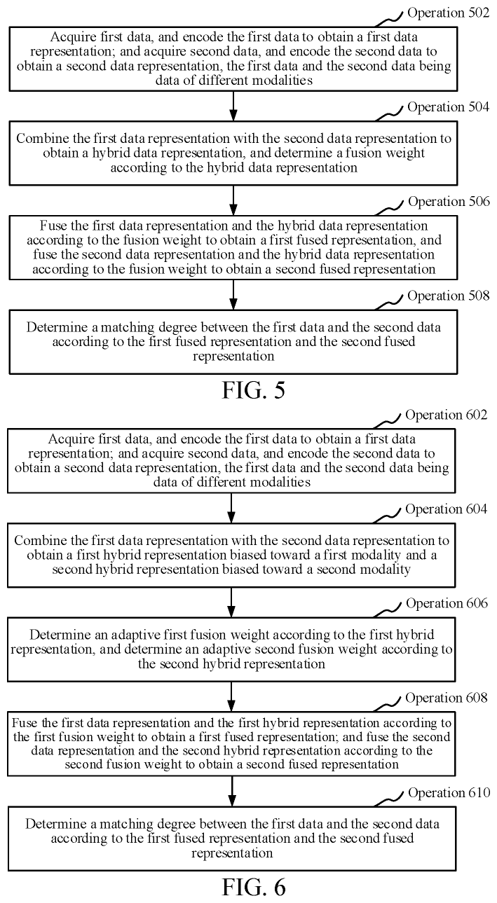

In an embodiment, as shown in FIG. 5, a data matching method is provided. An example in which the method is applied to a computer device (for example, the terminal or the server in FIG. 1) is used for description. The method includes the following operations.

Operation 502: Acquire first data, and encode the first data to obtain a first data representation; and acquire second data, and encode the second data to obtain a second data representation, the first data and the second data being data of different modalities.

The computer device may separately encode the first data and the second data to obtain the first data representation and the second data representation, the first data and the second data being data of different modalities.

In this disclosure, encoding may be performed based on the first data through a first encoder in the multimodal model to obtain the first data representation. Encoding may be performed based on the second data through a second encoder in the multimodal model to obtain the second data representation.

In some embodiments, the computer device may directly encode the first data to obtain the first data representation, and directly encode the second data to obtain the second data representation. In other embodiments, the computer device may mask the first data, and then encode masked first data through the first encoder in the multimodal model to obtain the first data representation. The computer device may mask the second data, and then encode masked second data through the second encoder in the multimodal model to obtain the second data representation.

For ease of description, data inputted to the first encoder may be referred to as a first input sequence, and data inputted to the second encoder may be referred to as a second input sequence. That is, the first input sequence may be the first data, or may be the masked first data. The second input sequence may be the second data, or may be the masked second data.

In some embodiments, the multimodal model encodes the first input sequence multiple times to obtain the first data representation. The multimodal model encodes the second input sequence multiple times to obtain the second data representation.

In some embodiments, the first encoder and the second encoder have a same network structure. Therefore, the manner for encoding the first input sequence is the same as the manner for encoding the second input sequence. Certainly, in another embodiment, the first encoder and the second encoder may have different network structures. The manner for encoding the first input sequence is different from the manner for encoding the second input sequence. This is not limited in this disclosure.

An example in which the first encoder and the second encoder have the same network structure is used for description. For any encoding, for example, (l+1)^{th} encoding, output of l^{th} encoding may be acquired first. According to the output of the l^{th} encoding, a multi-head self-attention layer operation is performed. A multi-head self-attention layer operation result is combined with the output of the l^{th} encoding, and then a layer normalization operation is performed to obtain intermediate processing features. Feedforward neural network processing is performed on the intermediate processing features. A feedforward neural network processing result is combined with the intermediate processing features, and then a layer normalization operation is performed to obtain output of the (l+1)^{th} encoding. l+1 is used as new l, and the operation of acquiring output of l^{th} encoding is returned to continue execution until the last encoding is completed. The output of the last encoding is used as the first data representation or the second data representation. l is a natural number greater than or equal to 0. When l is 0, the acquired output of the l^{th} encoding is the first input sequence or the second input sequence.

In some embodiments, the computer device may encode each piece of input data in the first input sequence multiple times to obtain output corresponding to each piece of input data, and then concatenate output corresponding to each piece of input data in the last encoding to obtain the first data representation. Similarly, the computer device may encode each piece of input data in the second input sequence multiple times to obtain output corresponding to each piece of input data, and then concatenate output corresponding to each piece of input data in the last encoding to obtain the second data representation.

Illustratively, the computer device may determine the output of the (l+1)^{th} encoding through formula (1) in operation 202.

Operation 504: Combine the first data representation with the second data representation to obtain a hybrid data representation, and determine a fusion weight according to the hybrid data representation.

A GIM is designed in this disclosure to control a ratio of a single data representation to a hybrid data representation to be referred to during decoding, that is, dynamically adjust a reference ratio through the fusion weight. The value range of the fusion weight may be [0, 1], or (0, 1).

In at least one embodiment, the multimodal model may fuse the first data representation and the second data representation through a cross transformer structure to obtain a hybrid data representation, and then perform numerical conversion on the hybrid data representation to obtain the fusion weight.

In some embodiments, the computer device may directly perform an addition or multiplication operation on the first data representation and a second data representation to obtain the hybrid data representation. In other embodiments, the computer device may further perform an attention operation on the first data representation and the second data representation to obtain the hybrid data representation. In another embodiment, the computer device may further adopt more complex operations, for example, perform attention mechanism processing, then perform matrix addition or multiplication, and then perform linear/nonlinear transformation, to obtain the hybrid data representation. A specific fusion manner is not limited in this disclosure.

Further, after combining the first data representation with the second data representation to obtain the hybrid data representation, the computer device may perform linear transformation on the hybrid data representation followed by activation, to obtain an adaptive fusion weight. That is, the hybrid data representation is converted into a value, and the value is the fusion weight. In this way, the current adaptive fusion weight may be obtained according to the current relationship between the first data and the second data.

Operation 506: Fuse the first data representation and the hybrid data representation according to the fusion weight to obtain a first fused representation, and fuse the second data representation and the hybrid data representation according to the fusion weight to obtain a second fused representation.

In at least one embodiment, the computer device may weight the first data representation and the hybrid data representation according to the fusion weight to obtain the first fused representation, and weight the second data representation and the hybrid data representation according to the fusion weight to obtain the second fused representation.

In some embodiments, the computer device may use the fusion weight as a weight of either of the first data representation and the hybrid data representation, use a difference between a value 1 and the fusion weight as a weight of the other representation, and perform weighted summation on the first data representation and the hybrid data representation.

In some embodiments, the computer device may use the fusion weight as a weight of either of the second data representation and the hybrid data representation, use a difference between a value 1 and the fusion weight as a weight of the other representation, and perform weighted summation on the second data representation and the hybrid data representation.

Operation 508: Determine a matching degree between the first data and the second data according to the first fused representation and the second fused representation.

In some embodiments, the computer device may directly calculate a matching degree between the first fused representation and the second fused representation, and use the matching degree as the matching degree between the first data and the second data. That is, in a use scene of the multimodal model, the first encoder, the second encoder, and the cross transformer structure may be directly used.

In other embodiments, the determining a matching degree between the first data and the second data according to the first fused representation and the second fused representation includes: decoding according to the first fused representation to obtain a first feature representation of the first data; decoding according to the second fused representation to obtain a second feature representation of the second data; and determining the matching degree between the first data and the second data based on the first feature representation and the second feature representation.

A specific decoding manner may refer to the decoding manner in the processing process of the multimodal model in the foregoing embodiment. A specific manner for determining the matching degree between the first data and the second data may be any one of the following manners: calculating a feature similarity between two representations (the first fused representation and the second fused representation, or the first feature representation and the second feature representation), and using the feature similarity as the matching degree; and inputting two representations (the first fused representation and the second fused representation, or the first feature representation and the second feature representation) to the classification layer, outputting a classification result through the classification layer, and using the classification result as the matching degree. The feature similarity may be represented through a cosine similarity, a Euclidean distance, a Manhattan distance, or the like.

According to the foregoing data matching method, the first data and the second data that belong to different modalities are separately encoded, to obtain the first data representation and the second data representation. Further, the first data representation is combined with the second data representation to obtain the hybrid data representation, and the fusion weight may be obtained according to the hybrid data representation. The fusion weight is configured for controlling ratios of the first data representation and the second data representation to be separately fused with the hybrid data representation, that is, information may be intelligently extracted from a single modality/a hybrid modality to obtain the first fused representation and the second fused representation. The first fused representation and the second fused representation obtained in this way may better highlight related information of the first data and the second data. Therefore, the matching degree between the first data and the second data may be more accurately determined, thereby greatly improving the data processing effect.

Particularly when the first data and the second data are partially missing, information is intelligently extracted from the hybrid modality, a ratio of extracted information of the hybrid modality is intelligently selected, and the first fused representation of the first data and the second fused representation of the second data are obtained through multimodal information reconstruction, thereby compensating for missing information, greatly improving the matching accuracy, and improving the data processing performance.

In some embodiments, the combining the first data representation with the second data representation to obtain a hybrid data representation includes: performing multiple interactive fusions based on the first data representation and the second data representation to obtain a first hybrid representation biased toward a first modality and a second hybrid representation biased toward a second modality; and combining the first hybrid representation with the second hybrid representation to obtain the hybrid data representation.

In at least one embodiment, in the process of fusing the first data representation and the second data representation by the initial model, multiple fusions may be performed through multiple layers of neural networks to obtain the first hybrid representation biased toward the first modality and the second hybrid representation biased toward the second modality. In at least one embodiment, for each interactive fusion, the second intermediate hybrid representation may be fused into the first intermediate hybrid representation based on an attention mechanism to obtain the first intermediate hybrid representation biased toward the first modality. The first intermediate hybrid representation is fused into the second intermediate hybrid representation based on the attention mechanism to obtain the second intermediate hybrid representation biased toward the second modality. In this way, a first intermediate hybrid representation outputted by the last layer of the neural network is the first hybrid representation, and a second intermediate hybrid representation outputted by the last layer of the neural network is the second hybrid representation.

In some examples, the one or more fusion weights include a first fusion weight determined based on the first hybrid representation and a second fusion weight determined based on the second hybrid representation. In some examples, the fusing the first data representation and the hybrid data representation includes fusing the first data representation and the first hybrid representation based on the first fusion weight to obtain the first fused representation. In some examples, the fusing the second data representation and the hybrid data representation includes fusing the second data representation and the second hybrid representation based on the second fusion weight to obtain the second fused representation.

Further, the initial model may fuse the first hybrid representation and the second hybrid representation to obtain the hybrid data representation. For example, fusion is performed through weighted summation, contacting, concatenating, or the like. This is not limited in this disclosure.

In the foregoing embodiment, multiple interactive fusions are performed on the first data representation and the second data representation through the initial model to obtain the first hybrid representation biased toward the first modality and the second hybrid representation biased toward the second modality. Relationship information between the first data and the second data may be fully extracted, and then the first hybrid representation is combined with the second hybrid representation to obtain the hybrid data representation.

In some embodiments, the performing multiple interactive fusions based on the first data representation and the second data representation to obtain a first hybrid representation biased toward a first modality and a second hybrid representation biased toward a second modality includes: acquiring, when performing an (i+1)^{th} interactive fusion, a first intermediate hybrid representation and a second intermediate hybrid representation that are outputted by an i^{th} interactive fusion; fusing the second intermediate hybrid representation into the first intermediate hybrid representation to obtain a first intermediate hybrid representation of the (i+1)^{th} interactive fusion; fusing the first intermediate hybrid representation into the second intermediate hybrid representation to obtain a second intermediate hybrid representation of the (i+1)^{th} interactive fusion; using i+1 as new i, and returning to the operation of acquiring, when performing an (i+1)^{th} interactive fusion, a first intermediate hybrid representation and a second intermediate hybrid representation that are outputted by an i^{th} interactive fusion to continue execution until a stopping condition is satisfied; and using a first intermediate hybrid representation outputted by a last interactive fusion as the first hybrid representation, and using a second intermediate hybrid representation outputted by the last interactive fusion as the second hybrid representation, i being a natural number greater than or equal to 0; and when i is 0, an acquired first intermediate hybrid representation outputted by the i^{th} interactive fusion being the first data representation, and an acquired second intermediate hybrid representation outputted by the i^{th} interactive fusion being the second data representation.

In at least one embodiment, for the first interactive fusion, the initial model may fuse the second data representation into the first data representation based on the attention mechanism to obtain a first intermediate hybrid representation, and fuse the first data representation into the second data representation based on the attention mechanism to obtain a second intermediate hybrid representation.

For the second interactive fusion, the initial model may fuse the second intermediate hybrid representation obtained through the first interactive fusion into the first intermediate hybrid representation based on the attention mechanism to obtain a new first intermediate hybrid representation. The first intermediate hybrid representation obtained through the first interactive fusion is fused into the second intermediate hybrid representation based on the attention mechanism to obtain a new second intermediate hybrid representation.

In this way, in each interactive fusion process, a current interactive fusion is continuously performed according to output of previous interactive fusion until the last interactive fusion. The initial model may directly output a first intermediate hybrid representation and a second intermediate hybrid representation obtained through the last interactive fusion. The currently outputted first intermediate hybrid representation is the first hybrid representation, and the currently outputted second intermediate hybrid representation is the second hybrid representation.

In the foregoing embodiment, after the first data representation and the second data representation are fused, the next interactive fusion is continuously performed based on the previous output through the iterative loop, so that information obtained from each fusion may be better utilized, ensuring more sufficient information fusion.

In some embodiments, the fusing the second intermediate hybrid representation into the first intermediate hybrid representation to obtain a first intermediate hybrid representation of the (i+1)^{th} interactive fusion includes: performing an attention operation according to the first intermediate hybrid representation and the second intermediate hybrid representation that are outputted by the i^{th} interactive fusion, combining an attention operation result with the first intermediate hybrid representation outputted by the i^{th} interactive fusion, and then performing a layer normalization operation to obtain first intermediate processing features; and performing feedforward neural network processing on the first intermediate processing features, combining a feedforward neural network processing result with the first intermediate processing features, and then performing a layer normalization operation to obtain the first intermediate hybrid representation of the (i+1)^{th} interactive fusion.

In at least one embodiment, when the layer normalization operation is performed after the attention operation result is combined with the first intermediate hybrid representation outputted by the i^{th} interactive fusion, a combination manner of the attention operation result and the first intermediate hybrid representation outputted by the i^{th} interactive fusion may be addition, multiplication, concatenation, or the like. This is not limited in this disclosure. When the layer normalization operation is performed after the feedforward neural network processing result is combined with the first intermediate processing features, a combination manner of the feedforward neural network processing result and the first intermediate processing features may be addition, multiplication, concatenation, or the like. This is not limited in this disclosure.

Similar to the processing manner in the model training process, the computer device may determine the first intermediate hybrid representation of the (i+1)^{th} interactive fusion through the foregoing formula 10 and formula 11.

In the foregoing embodiment, in the interactive fusion manner based on the attention mechanism, the second intermediate hybrid representation may be better fused into the first intermediate hybrid representation. In addition, through such a stacked fusion design, gradient explosion may be prevented during model training.

In some embodiments, the fusing the first intermediate hybrid representation into the second intermediate hybrid representation to obtain a second intermediate hybrid representation of the (i+1)^{th} interactive fusion includes: performing an attention operation according to the second intermediate hybrid representation and the first intermediate hybrid representation that are outputted by the i^{th} interactive fusion, combining an attention operation result with the second intermediate hybrid representation outputted by the i^{th} interactive fusion, and then performing a layer normalization operation to obtain second intermediate processing features; and performing feedforward neural network processing on the second intermediate processing features, combining a feedforward neural network processing result with the second intermediate processing features, and then performing a layer normalization operation to obtain the second intermediate hybrid representation of the (i+1)^{th} interactive fusion.

In at least one embodiment, when the layer normalization operation is performed after the attention operation result is combined with the second intermediate hybrid representation outputted by the i^{th} interactive fusion, a combination manner of the attention operation result and the second intermediate hybrid representation outputted by the i^{th} interactive fusion may be addition, multiplication, concatenation, or the like. This is not limited in this disclosure. When the layer normalization operation is performed after the feedforward neural network processing result is combined with the second intermediate processing features, a combination manner of the feedforward neural network processing result and the second intermediate processing features may be addition, multiplication, concatenation, or the like. This is not limited in this disclosure.

Similar to the processing manner in the model training process, the computer device may determine the second intermediate hybrid representation of the (i+1)^{th} interactive fusion through formula 12 and formula 13 in the foregoing embodiments.

In the foregoing embodiment, in the interactive fusion manner based on the attention mechanism, the first intermediate hybrid representation may be better fused into the second intermediate hybrid representation. In addition, through such a stacked fusion design, gradient explosion may be prevented during model training.

In some embodiments, the fusing the first data representation and the hybrid data representation according to the fusion weight to obtain a first fused representation includes: using the fusion weight as a coefficient of the hybrid data representation, and using a difference between a value 1 and the fusion weight as a coefficient of the first data representation; and weighting the hybrid data representation and the first data representation according to the coefficient of the hybrid data representation and the coefficient of the first data representation to obtain the first fused representation.

In at least one embodiment, the initial model may perform weighted summation on the hybrid data representation and the first data representation according to the coefficient of the hybrid data representation and the coefficient of the first data representation to obtain the first fused representation.

In the foregoing embodiment, by fusing the hybrid data representation and the first modality according to the fusion weight, the ratio of the single data representation to the hybrid data representation may be flexibly referred to according to the alignment quality of data of two modalities, so that the fused representation may better express information of the single-modality data.

In some embodiments, the fusing the second data representation and the hybrid data representation according to the fusion weight to obtain a second fused representation includes: using the fusion weight as the coefficient of the hybrid data representation, and using the difference between the value 1 and the fusion weight as a coefficient of the second data representation; and weighting the hybrid data representation and the second data representation according to the coefficient of the hybrid data representation and the coefficient of the second data representation to obtain the second fused representation.

In at least one embodiment, the initial model may perform weighted summation on the hybrid data representation and the second data representation according to the coefficient of the hybrid data representation and the coefficient of the second data representation to obtain the second fused representation.

In the foregoing embodiment, by fusing the hybrid data representation and the second modality according to the fusion weight, the ratio of the single data representation to the hybrid data representation may be flexibly referred to according to the alignment quality of data of two modalities, so that the fused representation may better express information of the single-modality data.

In some embodiments, referring to FIG. 6, the data matching method includes the following operations.

Operation 602: Acquire first data, and encode the first data to obtain a first data representation; and acquire second data, and encode the second data to obtain a second data representation, the first data and the second data being data of different modalities.

Operation 604: Combine the first data representation with the second data representation to obtain a first hybrid representation biased toward a first modality and a second hybrid representation biased toward a second modality.

Operation 606: Determine an adaptive first fusion weight according to the first hybrid representation, and determine an adaptive second fusion weight according to the second hybrid representation.

In at least one embodiment, the multimodal model may perform linear transformation on the first hybrid representation followed by activation to obtain the first fusion weight; and perform linear transformation on the second hybrid representation followed by activation to obtain the second fusion weight.

Operation 608: Fuse the first data representation and the first hybrid representation according to the first fusion weight to obtain a first fused representation; and fuse the second data representation and the second hybrid representation according to the second fusion weight to obtain a second fused representation.

In at least one embodiment, the multimodal model may use the first fusion weight as a coefficient of the first hybrid representation, and use a difference between a value 1 and the first fusion weight as a coefficient of the first data representation; and perform weighted summation on the first hybrid representation and the first data representation according to the coefficient of the first hybrid representation and the coefficient of the first data representation, and then decode based on a result of the weighted summation to obtain the first predicted feature representation.

The multimodal model may use the second fusion weight as a coefficient of the second hybrid representation, and use a difference between the value 1 and the second fusion weight as a coefficient of the second data representation; and perform weighted summation on the second hybrid representation and the second data representation according to the coefficient of the second hybrid representation and the coefficient of the second data representation, and then decode based on a result of the weighted summation to obtain the second predicted feature representation.

Operation 610: Determine a matching degree between the first data and the second data according to the first fused representation and the second fused representation.

In the foregoing embodiment, for the first modality, the multimodal model may use the first modality as main information, fuse information of the second data representation to obtain the first hybrid representation, and then determine the fusion weight of the first modality, that is, the first fusion weight, according to the first hybrid representation. In this way, the ratio of the single-modality information to the hybrid-modality information to be referred to during decoding of the first modality may be subsequently controlled according to the first fusion weight. For the second modality, the multimodal model may use the second modality as main information, fuse information of the first data representation to obtain the second hybrid representation, and then determine the fusion weight of the second modality, that is, the second fusion weight, according to the second hybrid representation. In this way, the ratio of the single-modality information to the hybrid-modality information to be referred to during decoding of the second modality may be subsequently controlled according to the second fusion weight. In this way, different modalities may be more flexible and adaptive when fusing the hybrid-modality information.

In some embodiments, the first data includes image data, and the second data includes text data. The method further includes: determining a text retrieval result of specified image data based on matching degrees between the specified image data and multiple pieces of different text data; and/or determining an image retrieval result of specified text data based on matching degrees between the specified text data and multiple pieces of different image data.

In at least one embodiment, for a specific manner for determining the text retrieval result based on the matching degree, text data whose matching degree satisfies the push condition may be used as the text retrieval result. For a specific manner for determining the image retrieval result based on the matching degree, image data whose matching degree satisfies the push condition may be used as the image retrieval result.

The matching degree satisfying the push condition may refer to the highest matching degree, the matching degree exceeding a preset threshold, the top N highest matching degrees, or the like. This is not limited in this disclosure.

In the foregoing embodiment, matching calculation of the image and the text may be realized through the trained multimodal model, thereby helping improve the image-text retrieval quality and efficiency.

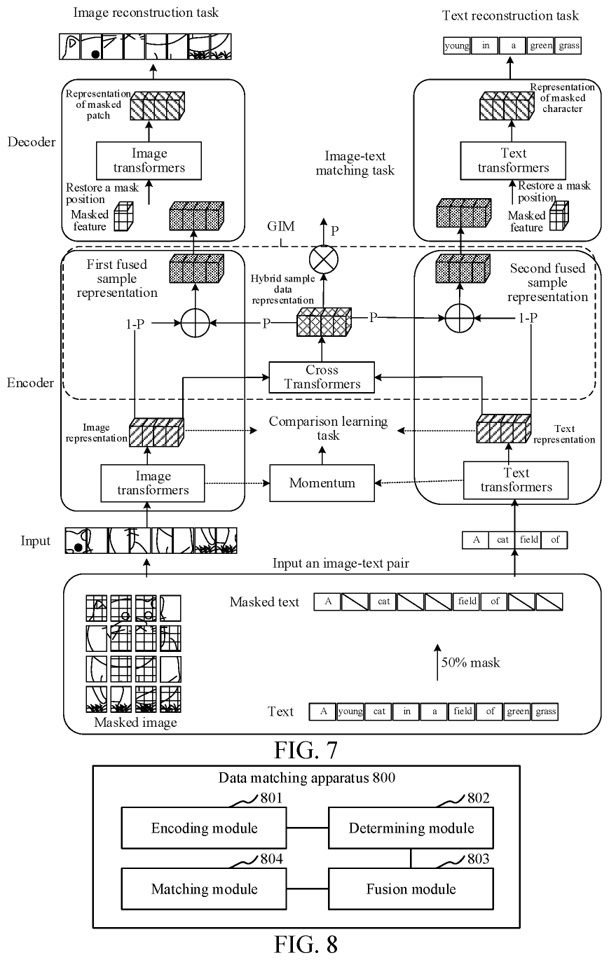

In a specific embodiment, an example in which a first modality is an image modality and a second modality is a text modality is used for description. FIG. 7 is a structural block diagram of a multimodal model according to an embodiment.

A model training stage is used as an example for description. As shown in FIG. 7, a multimodal model of this disclosure (e.g., a LightVLP model) uses two separate encoders to model different modality information. For one modality, for example, image input, the model randomly masks a particular ratio (for example, 50%) of patches. Then, the remaining patches form a sequence, and the sequence is inputted to an image transformer to obtain an image representation (in the training stage, corresponding to the first sample data representation in the foregoing embodiment). Correspondingly, for text input, the model randomly masks a particular ratio of characters. Then, the remaining characters form a sequence, and the sequence is inputted to a text transformer to obtain a text representation (in a training stage, corresponding to the second sample data representation in the foregoing embodiment).

The image representation and the text representation are inputted to the cross transformer, and are processed through the cross transformer to output a hybrid-modality sample representation. Further, a fusion weight p is determined through the hybrid data representation. The image representation and the hybrid-modality sample representation are fused through the fusion weight p to obtain the first fused sample representation, and the text representation and the hybrid-modality sample representation are fused through the fusion weight p to obtain the second fused sample representation.

Further, decoding is performed based on the first fused sample representation and masked features of the image to obtain representations of masked patches, and decoding is performed based on the second fused sample representation and masked features of the text to obtain representations of masked characters. In this disclosure, two image/text unsupervised training tasks, that is, an image reconstruction task and a text reconstruction task, are introduced to construct a first modality loss and a second modality loss. An image-text matching task is further introduced to construct a second loss. A comparison learning task is further introduced to construct a third loss. The model is trained through joint task learning.

For the trained multimodal model, in some application scenes, the trained multimodal model may be used as a VLP model, that is, a large model. For a specific downstream task, the multimodal model may be fine-tuned based on a downstream task requirement to obtain a task model applicable to the specific downstream task. The downstream task is, for example, a task of generating text based on an image, generating an image based on text, or generating a title of an image.

In some application scenes, the multimodal model may be configured to restore original data. For example, the input data includes first data and second data of two modalities. The first data is an image missing a part of data, and the second data is text missing a part of data. Further, the missing image and the missing text may be outputted through the multimodal model.

In some embodiments, for the foregoing trained multimodal model, an effect test is further performed in this disclosure. Referring to Table 1, it may be learned from the results presented in Table 1 that the model of this disclosure demonstrates significant improvements in efficiency and effect compared with the baseline model.

TABLE 1
Test results of different models in operational speed and recall rate

| | GFLOPs | | | | | | | | | | | | |
|---|---|---|---|---|---|---|---|---|---|---|---|---|---|
| | (opera- | First data set (MS COCO) | | | | | | Second data set (Flickr30k) | | | | | |
| | tional | TR | | | IR | | | TR | | | IR | | |
| Model | speed) | R@1 | R@5 | R@10 | R@1 | R@5 | R@10 | R@1 | R@5 | R@10 | R@1 | R@5 | R@10 |
| Model 1- | — | 65.7 | 88.6 | 93.8 | 52.9 | 79.9 | 88.0 | 87.3 | 98.0 | 99.2 | 75.6 | 94.1 | 96.8 |
| UNITER | | | | | | | | | | | | | |
| Model 2- | — | — | — | — | — | — | — | 87.9 | 97.5 | 98.8 | 76.3 | 94.2 | 96.8 |
| VILLA | | | | | | | | | | | | | |
| Model 3- | — | 70.0 | 91.1 | 95.5 | 54.0 | 80.8 | 88.5 | — | — | — | — | — | — |
| OSCAR | | | | | | | | | | | | | |
| Model 4- | — | — | — | — | — | — | — | 89.4 | 98.9 | 99.8 | 78.0 | 94.2 | 97.1 |
| UNIMO | | | | | | | | | | | | | |
| Model 5- | 135.9 | 73.1 | 91.4 | 96.0 | 56.8 | 81.5 | 89.2 | 94.3 | 99.4 | 99.8 | 82.8 | 96.7 | 98.4 |
| ALBEF | | | | | | | | | | | | | |
| LightVLP | 124.4 | 75.1 | 93.2 | 96.6 | 57.6 | 82.2 | 89.4 | 94.4 | 99.6 | 99.7 | 82.5 | 96.5 | 98.6 |

The TR refers to the text retrieval task, and the IR refers to the image retrieval task.

In addition, an ablation experiment is further performed to verify the effectiveness of the gated interactive policy (the gate part) in the multimodal model in this disclosure. Test data may refer to the following Table 2.

TABLE 2
Ablation experiment results

| | TR | | | IR | | |
|---|---|---|---|---|---|---|
| Model | R@1 | R@5 | R@10 | R@1 | R@5 | R@10 |
| LightVLP | 75.3 | 93.18 | 96.64 | 57.63 | 82.24 | 89.38 |
| Model without | 73.8 | 92.9 | 96.5 | 56.9 | 81.8 | 89.04 |
| gate policy | | | | | | |

From the foregoing Table 2, the model of this disclosure having the gated interactive policy demonstrates a significant improvement in the recall rate.

Finally, an elaborate test is performed for different mask ratios, and the conclusion is as follows in Table 3.

TABLE 3
Test effect table of different mask ratios

| Image | Text | | TR | | | | TR | | | | |
|---|---|---|---|---|---|---|---|---|---|---|---|
| mask | mask | | | | | Average | | | | Average | Average |
| ratio | ratio | GFLOPs | R@1 | R@5 | R@10 | R | R@1 | R@5 | R@10 | R | R |
| 25% | 25% | 168.00 | 74.90 | 92.54 | 96.52 | 87.99 | 57.49 | 82.49 | 89.38 | 76.45 | 82.22 |
| 25% | 50% | 165.60 | 74.80 | 92.74 | 96.48 | 88.01 | 57.02 | 82.11 | 89.38 | 76.17 | 82.09 |
| 25% | 75% | 163.20 | 74.10 | 92.78 | 96.24 | 87.71 | 55.95 | 81.30 | 88.66 | 75.30 | 81.51 |
| 50% | 25% | 126.90 | 74.66 | 92.32 | 96.30 | 87.76 | 57.25 | 81.92 | 89.06 | 76.07 | 81.92 |
| 50% | 50% | 124.40 | 75.30 | 93.18 | 96.64 | 88.37 | 57.63 | 82.24 | 89.38 | 76.42 | 82.39 |
| 50% | 75% | 122.00 | 74.46 | 92.02 | 96.14 | 87.54 | 56.12 | 81.31 | 88.97 | 75.47 | 81.50 |
| 75% | 25% | 85.70 | 74.20 | 92.72 | 96.30 | 87.74 | 56.63 | 81.61 | 89.13 | 75.79 | 81.77 |
| 75% | 50% | 83.30 | 73.98 | 92.16 | 95.84 | 87.32 | 56.04 | 81.32 | 88.53 | 75.29 | 81.31 |
| 75% | 75% | 80.90 | 72.74 | 92.10 | 95.92 | 86.92 | 54.64 | 80.50 | 88.21 | 74.45 | 80.69 |

From the foregoing test results, the multimodal model provided in this disclosure has advantages in flexibility and efficiency compared with other VLP models, and a dual-encoding structure is also more applicable to an image-text retrieval task.

Although various operations in the flowcharts involved in the above embodiments are shown sequentially as indicated by the arrows, these operations are not necessarily performed in the order indicated by the arrows. These operations are performed in no strict order unless explicitly stated herein, and these operations may be performed in other orders. Moreover, at least some of the operations in the flowcharts involved in the above embodiments may include multiple operations or multiple stages. These operations or stages are not necessarily performed at the same moment, but may be performed at different moments. These operations or stages are not necessarily performed in sequence, but may be performed in turn or in alternation with other operations or at least some of the operations or stages in other operations.

Based on the same inventive concept, the embodiments of this disclosure further provide a data matching apparatus configured to implement the foregoing data matching method. Implementation solutions provided by the apparatus for resolving problems are similar to the implementation solutions described in the foregoing method. Therefore, specific limitations in one or more embodiments of the data matching apparatus provided below may refer to the limitations on the data matching method in the foregoing descriptions. Details are not described herein again.

In an embodiment, as shown in FIG. 8, a data matching apparatus 800 is provided, including an encoding module 801, a determining module 802, a fusion module 803, and a matching module 804.

The encoding module is configured to acquire first data, and encode the first data to obtain a first data representation; and acquire second data, and encode the second data to obtain a second data representation, the first data and the second data being data of different modalities.

The determining module is configured to combine the first data representation with the second data representation to obtain a hybrid data representation, and determine a fusion weight according to the hybrid data representation.

The fusion module is configured to fuse the first data representation and the hybrid data representation according to the fusion weight to obtain a first fused representation, and fuse the second data representation and the hybrid data representation according to the fusion weight to obtain a second fused representation.

The matching module is configured to determine a matching degree between the first data and the second data according to the first fused representation and the second fused representation.

In some embodiments, the determining module is further configured to perform multiple interactive fusions based on the first data representation and the second data representation to obtain a first hybrid representation biased toward a first modality and a second hybrid representation biased toward a second modality; and combine the first hybrid representation with the second hybrid representation to obtain the hybrid data representation.

In some embodiments, the determining module is further configured to acquire, when performing an (i+1)^{th} interactive fusion, a first intermediate hybrid representation and a second intermediate hybrid representation that are outputted by an i^{th} interactive fusion; fuse the second intermediate hybrid representation into the first intermediate hybrid representation to obtain a first intermediate hybrid representation of the (i+1)^{th} interactive fusion; fuse the first intermediate hybrid representation into the second intermediate hybrid representation to obtain a second intermediate hybrid representation of the (i+1)^{th} interactive fusion; use i+1 as new i, and return to the operation of acquiring, when performing an (i+1)^{th} interactive fusion, a first intermediate hybrid representation and a second intermediate hybrid representation that are outputted by an i^{th} interactive fusion to continue execution until a stopping condition is satisfied; and use a first intermediate hybrid representation outputted by a last interactive fusion as the first hybrid representation, and use a second intermediate hybrid representation outputted by the last interactive fusion as the second hybrid representation, i being a natural number greater than or equal to 0; and when i is 0, an acquired first intermediate hybrid representation outputted by the i^{th} interactive fusion being the first data representation, and an acquired second intermediate hybrid representation outputted by the i^{th} interactive fusion being the second data representation.

In some embodiments, the determining module is further configured to perform an attention operation according to the first intermediate hybrid representation and the second intermediate hybrid representation that are outputted by the i^{th} interactive fusion, combine an attention operation result with the first intermediate hybrid representation outputted by the i^{th} interactive fusion, and then perform a layer normalization operation to obtain first intermediate processing features; and perform feedforward neural network processing on the first intermediate processing features, combine a feedforward neural network processing result with the first intermediate processing features, and then perform a layer normalization operation to obtain the first intermediate hybrid representation of the (i+1)^{th} interactive fusion.

In some embodiments, the determining module is further configured to perform an attention operation according to the second intermediate hybrid representation and the first intermediate hybrid representation that are outputted by the i^{th} interactive fusion, combine an attention operation result with the second intermediate hybrid representation outputted by the i^{th} interactive fusion, and then perform a layer normalization operation to obtain second intermediate processing features; and perform feedforward neural network processing on the second intermediate processing features, combine a feedforward neural network processing result with the second intermediate processing features, and then perform a layer normalization operation to obtain the second intermediate hybrid representation of the (i+1)^{th} interactive fusion.

In some embodiments, the determining module is further configured to perform linear transformation on the hybrid data representation followed by activation, to obtain the fusion weight.

In some embodiments, the fusion module is further configured to use the fusion weight as a coefficient of the hybrid data representation, and use a difference between a value 1 and the fusion weight as a coefficient of the first data representation; and weight the hybrid data representation and the first data representation according to the coefficient of the hybrid data representation and the coefficient of the first data representation to obtain the first fused representation.

In some embodiments, the fusion module is further configured to use the fusion weight as the coefficient of the hybrid data representation, and use the difference between the value 1 and the fusion weight as a coefficient of the second data representation; and weight the hybrid data representation and the second data representation according to the coefficient of the hybrid data representation and the coefficient of the second data representation to obtain the second fused representation.

In some embodiments, the hybrid data representation includes the first hybrid representation biased toward the first modality and the second hybrid representation biased toward the second modality, and the fusion weight includes a first fusion weight determined according to the first hybrid representation and a second fusion weight determined according to the second hybrid representation. The fusion module is further configured to fuse the first data representation and the first hybrid representation according to the first fusion weight to obtain a first fused representation; and fuse the second data representation and the second hybrid representation according to the second fusion weight to obtain a second fused representation.

In some embodiments, the matching module is further configured to decode according to the first fused representation to obtain a first feature representation of the first data; decode according to the second fused representation to obtain a second feature representation of the second data; and determine the matching degree between the first data and the second data based on the first feature representation and the second feature representation.

In some embodiments, the first data includes image data, and the second data includes text data. The apparatus further includes a retrieval module, configured to determine a text retrieval result of specified image data based on matching degrees between the specified image data and multiple pieces of different text data; and/or determine an image retrieval result of specified text data based on matching degrees between the specified text data and multiple pieces of different image data.

Based on the same inventive concept, the embodiments of this disclosure further provide a multimodal model processing apparatus configured to implement the foregoing multimodal model processing method. Implementation solutions provided by the apparatus for resolving problems are similar to the implementation solutions described in the foregoing method. Therefore, specific limitations in one or more embodiments of the multimodal model processing apparatus provided below may refer to the limitations on the multimodal model processing method in the foregoing descriptions. Details are not described herein again.

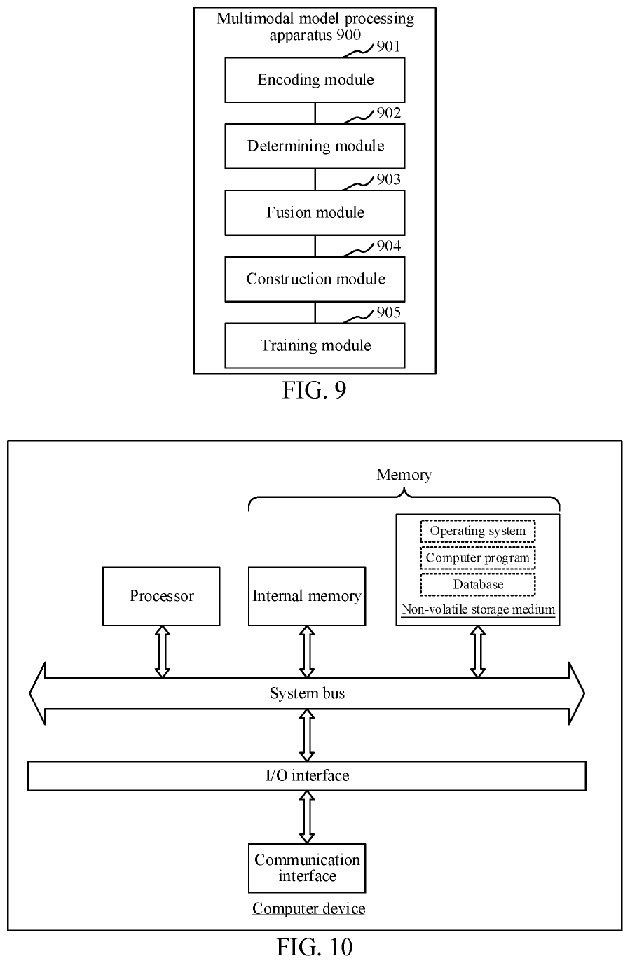

In an embodiment, as shown in FIG. 9, a multimodal model processing apparatus 900 is provided, including an encoding module 901, a determining module 902, a fusion module 903, a construction module 904, and a training module 905.

The encoding module is configured to encode based on first sample data and second sample data in a training sample pair through a to-be-trained initial model to obtain a first sample data representation and a second sample data representation, the first sample data and the second sample data being sample data of different modalities.

The determining module is configured to combine the first sample data representation with the second sample data representation through the initial model to obtain a hybrid sample data representation, and determine a prediction weight according to the hybrid sample data representation.

The fusion module is configured to fuse the first sample data representation and the hybrid sample data representation according to the prediction weight through the initial model, and decode based on a fused result to obtain a first predicted feature representation.

The fusion module is further configured to fuse the second sample data representation and the hybrid sample data representation according to the prediction weight through the initial model, and decode based on a fused result to obtain a second predicted feature representation.

The construction module is configured to determine a first loss based on a real feature representation and the first predicted feature representation of the first sample data, and a real feature representation and the second predicted feature representation of the second sample data; determine a second loss based on an alignment label of the first sample data and the second sample data and the prediction weight; and construct a target loss function according to the first loss and the second loss.

The training module is configured to train the to-be-trained initial model based on the target loss function to obtain, after the training is completed, the multimodal model.

In some embodiments, the apparatus further includes a masking module, configured to acquire the training sample pair, the training sample pair including the first sample data and the second sample data; split the first sample data to obtain multiple first data blocks, and split the second sample data to obtain multiple second data blocks; and extract some data blocks of the multiple first data blocks to form a first input sequence, and extract some data blocks of the multiple second data blocks to form a second input sequence. The encoding module is configured to encode the first input sequence multiple times to obtain the first sample data representation, and encode the second input sequence multiple times to obtain the second sample data representation.

In some embodiments, the determining module is further configured to perform multiple interactive fusions on the first sample data representation and the second sample data representation through the initial model to obtain a first hybrid sample representation biased toward a first modality and a second hybrid sample representation biased toward a second modality; and combine the first hybrid sample representation with the second hybrid sample representation to obtain the hybrid sample data representation.

In some embodiments, the construction module is further configured to construct a first vector based on the alignment label of the first sample data and the second sample data; construct a second vector according to the prediction weight and a difference between a value 1 and the prediction weight; and determine a second loss according to the first vector and the second vector.

In some embodiments, the hybrid sample data representation includes the first hybrid sample representation biased toward the first modality and the second hybrid sample representation biased toward the second modality, and the prediction weight includes a first prediction weight determined according to the first hybrid sample representation and a second prediction weight determined according to the second hybrid sample representation. The fusion module is further configured to fuse the first sample data representation and the first hybrid sample representation according to the first prediction weight through the initial model; and fuse the second sample data representation and the second hybrid sample representation according to the second prediction weight through the initial model.

In some embodiments, the hybrid sample data representation includes the first hybrid sample representation biased toward the first modality and the second hybrid sample representation biased toward the second modality, and the prediction weight includes the first prediction weight determined according to the first hybrid sample representation and the second prediction weight determined according to the second hybrid sample representation. The construction module is further configured to construct a first vector based on the alignment label of the first sample data and the second sample data; determine a target weight according to an average value of the first prediction weight and the second prediction weight, and construct a second vector based on the target weight and a difference between the value 1 and the target weight; and determine the second loss according to the first vector and the second vector.

In some embodiments, the construction module is further configured to determine a correlation between the first sample data and the second sample data according to the first sample data representation and the second sample data representation; determine a third loss based on the alignment label of the first sample data and the second sample data and the correlation between the first sample data and the second sample data; and construct the target loss function according to the first loss, the second loss, and the third loss.

In some embodiments, the correlation between the first sample data and the second sample data includes a correlation of the first sample data with respect to the second sample data and a correlation of the second sample data with respect to the first sample data. The construction module is further configured to determine a preset quantity of pieces of third sample data having a same modality as the first sample data, and a preset quantity of pieces of fourth sample data having a same modality as the second sample data; calculate the correlation of the first sample data with respect to the second sample data according to the first sample data representation, the second sample data representation, and sample data representations of the fourth sample data; and calculate the correlation of the second sample data with respect to the first sample data according to the first sample data representation, the second sample data representation, and sample data representations of the third sample data.

In some embodiments, the construction module is further configured to determine a first value according to the first sample data representation and the second sample data representation; determine multiple second values according to the first sample data representation and the sample data representations of the fourth sample data; and use a comparison value between the first value and a sum of the multiple second values as the correlation of the first sample data with respect to the second sample data.

In some embodiments, the apparatus further includes a retrieval module, configured to acquire a text retrieval task, extract specified image data in the text retrieval task, and form to-be-processed first data pairs using text data in a text library and the specified image data; process the first data pair through the multimodal model to obtain two feature representations, and determine a matching degree of the first data pair based on the two feature representations; and determine, according to matching degrees of the first data pairs, target text matching the specified image data.

In some embodiments, the apparatus further includes a retrieval module, configured to acquire an image retrieval task, extract specified text data in the image retrieval task, and form to-be-processed second data pairs using image data in an image library and the specified text data; process the second data pair through the multimodal model to obtain two feature representations, and determine a matching degree of the second data pair based on the two feature representations; and determine, according to matching degrees of the second data pairs, a target image matching the specified text data.

The modules in the foregoing apparatus may be partially or completely implemented through software, hardware, and a combination thereof. The foregoing modules may be embedded in the form of hardware or stored separately from a processor in a computer device, or may be stored in the form of software in a memory of the computer device, facilitating the processor to call the foregoing modules to perform the corresponding operations.

In an embodiment, a computer device is provided. The computer device may be a server or a terminal, and an internal structure diagram of the computer device is shown in FIG. 10. The computer device includes a processor, a memory, an input/output (I/O) interface, and a communication interface. The processor, the memory, and the I/O interface are connected through a system bus, and the communication interface is connected to the system bus through the I/O interface. The processor of the computer device is configured to provide calculation and control capabilities. The memory of the computer device includes a non-volatile storage medium and an internal memory. The non-volatile storage medium has an operating system, a computer program, and a database stored therein. The internal memory provides an environment for running the operating system and the computer program in the non-volatile storage medium. The database of the computer device is configured to store image-text data. The I/O interface of the computer device is configured to exchange information between the processor and an external device. The communication interface of the computer device is configured to communicate with an external terminal through a network connection. The computer program, when executed by the processor, implements a data matching method and/or a multimodal model processing method.

A person skilled in the art may understand that the structure shown in FIG. 10 is merely a block diagram of a part of the structure relevant to the solution of this disclosure and does not constitute a limitation on the computer device to which the solution of this disclosure is applied. A specific computer device may include more or fewer components than those shown in the drawings, a combination of some components, or a different arrangement of components.

In an embodiment, a computer device is further provided, including a memory and a processor. The memory has a computer program stored therein, and the processor, when executing the computer program, implements the operations in the foregoing method embodiments.

In an embodiment, a computer-readable storage medium is provided, having a computer program stored therein. The computer program, when executed by a processor, implements the operations in the foregoing method embodiments.

In an embodiment, a computer program product is provided, including a computer program. The computer program, when executed by a processor, implements the operations in the foregoing method embodiments.

A person skilled in the art may understand that all or some of the procedures of the method in the foregoing embodiments may be accomplished by instructing the relevant hardware through the computer program. The computer program may be stored in a non-volatile computer-readable storage medium and may include the procedures of the foregoing method embodiments when executed. Any reference to the memory, databases, or other media used in the embodiments provided by this disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM), an external cache memory, or the like. By way of illustration and not limitation, the RAM may be in a variety of forms, such as a static random access memory (SRAM) or a dynamic random access memory (DRAM). The database involved in various embodiments provided in this disclosure may include at least one of a relational database and a non-relational database. The non-relational database may include a blockchain-based distributed database or the like, but is not limited thereto. The processor involved in various embodiments provided in this disclosure may be a general-purpose processor, a central processing unit, a graphics processing unit, a digital signal processor, a programmable logic device, a data processing logic device based on quantum computing, or the like, but is not limited thereto.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Technical features of the foregoing embodiments may be combined in different manners to form other embodiments. To make description concise, not all possible combinations of the technical features in the foregoing embodiments are described. However, as long as no conflict exists, the combinations of these technical features shall be considered as falling within the scope of this disclosure.

The foregoing embodiments express only several implementations of this disclosure, but are not to be construed as a limitation of the scope of this disclosure. For a person skilled in the art, several transformations and improvements may be made without departing from this disclosure. These transformations and improvements are within the scope of this disclosure.

What is claimed is:

1. A data matching method, comprising:
encoding first data of a first modality to obtain a first data representation;
encoding second data of a second modality to obtain a second data representation, the first modality and the second modality corresponding to different modalities;
combining the first data representation and the second data representation to obtain a hybrid data representation;
determining, by processing circuitry, one or more fusion weights based on the hybrid data representation;
fusing the first data representation and the hybrid data representation based on the one or more fusion weights to obtain a first fused representation;
fusing the second data representation and the hybrid data representation based on the one or more fusion weights to obtain a second fused representation; and
determining, by the processing circuitry, a matching degree between the first data and the second data based on the first fused representation and the second fused representation.

2. The method according to claim 1, wherein the combining the first data representation and the second data representation comprises:
performing multiple interactive fusions based on the first data representation and the second data representation to obtain a first hybrid representation biased toward the first modality and a second hybrid representation biased toward the second modality; and
combining the first hybrid representation and the second hybrid representation to obtain the hybrid data representation.

3. The method according to claim 2, wherein the performing the multiple interactive fusions comprises performing an (i+1)^{th} interactive fusion that includes:
obtaining a first intermediate hybrid representation of an i^{th} interactive fusion and a second intermediate hybrid representation of the i^{th} interactive fusion;
fusing the second intermediate hybrid representation of the i^{th} interactive fusion into the first intermediate hybrid representation of the i^{th} interactive fusion to obtain a first intermediate hybrid representation of the (i+1)^{th} interactive fusion;
fusing the first intermediate hybrid representation of the i^{th} interactive fusion into the second intermediate hybrid representation of the i^{th} interactive fusion to obtain a second intermediate hybrid representation of the (i+1)^{th} interactive fusion; and
when a stopping condition is satisfied, outputting the first intermediate hybrid representation of the (i+1)^{th} interactive fusion as the first hybrid representation, and the second intermediate hybrid representation of the (i+1)^{th} interactive fusion as the second hybrid representation, wherein
i is an integer greater than or equal to 0, and
when i is 0, the first intermediate hybrid representation of the i^{th} interactive fusion corresponds to the first data representation, and the second intermediate hybrid representation of the i^{th} interactive fusion corresponds to the second data representation.

4. The method according to claim 3, wherein the fusing the second intermediate hybrid representation of the i^{th} interactive fusion into the first intermediate hybrid representation of the i^{th} interactive fusion to obtain the first intermediate hybrid representation of the (i+1)^{th} interactive fusion comprises:
performing an attention operation based on the first intermediate hybrid representation of the i^{th} interactive fusion and the second intermediate hybrid representation of the i^{th} interactive fusion;
combining an attention operation result of the attention operation and the first intermediate hybrid representation of the i^{th} interactive fusion followed by a first layer normalization operation to obtain first intermediate processing features;
performing feedforward neural network processing on the first intermediate processing features; and
combining a feedforward neural network processing result of the feedforward neural network processing and the first intermediate processing features followed by a second layer normalization operation to obtain the first intermediate hybrid representation of the (i+1)^{th} interactive fusion.

5. The method according to claim 1, wherein the determining the one or more fusion weights comprises:
performing linear transformation on the hybrid data representation followed by an activation processing, to obtain the one or more fusion weights.

6. The method according to claim 1, wherein
the hybrid data representation includes a first hybrid representation biased toward the first modality and a second hybrid representation biased toward the second modality,
the one or more fusion weights include a first fusion weight determined based on the first hybrid representation and a second fusion weight determined based on the second hybrid representation,
the fusing the first data representation and the hybrid data representation includes fusing the first data representation and the first hybrid representation based on the first fusion weight to obtain the first fused representation, and
the fusing the second data representation and the hybrid data representation includes fusing the second data representation and the second hybrid representation based on the second fusion weight to obtain the second fused representation.

7. The method according to claim 1, wherein the determining the matching degree comprises:
decoding the first fused representation to obtain a first feature representation of the first data;
decoding the second fused representation to obtain a second feature representation of the second data; and
determining the matching degree between the first data and the second data based on the first feature representation and the second feature representation.

8. The method according to claim 1, wherein
the first data includes image data, and
the method includes:
determining a text retrieval result of the image data based on matching degrees between the image data and different pieces of text data.

9. The method according to claim 1, wherein
the second data includes text data, and
the method includes:
determining an image retrieval result of the text data based on matching degrees between the text data and different pieces of image data.

10. A multimodal model processing method, comprising:
acquiring a training sample pair, the training sample pair including first sample data of a first modality and second sample data of a second modality, and the first modality and the second modality corresponding to different modalities;
encoding at least a portion of the first sample data through an initial model to obtain a first sample data representation;
encoding at least a portion of the second sample data through the initial model to obtain a second sample data representation;
combining the first sample data representation and the second sample data representation through the initial model to obtain a hybrid sample data representation;
determining, by processing circuitry, one or more prediction weights based on the hybrid sample data representation;
fusing, by the processing circuitry, the first sample data representation and the hybrid sample data representation based on the one or more prediction weights to obtain a first fused sample representation;
decoding the first fused sample representation through the initial model to obtain a first predicted feature representation;
fusing, by the processing circuitry, the second sample data representation and the hybrid sample data representation based on the one or more prediction weights to obtain a second fused sample representation;
decoding the second fused sample representation through the initial model to obtain a second predicted feature representation;
determining a first loss based on a first benchmark feature representation of the first sample data and the first predicted feature representation of the first sample data, and a second benchmark feature representation of the second sample data and the second predicted feature representation of the second sample data;
determining a second loss based on an alignment label of the first sample data and the second sample data and the one or more prediction weights;
constructing, by the processing circuitry, a target loss function based on the first loss and the second loss; and
updating, by the processing circuitry, the initial model based on the target loss function to obtain a trained multimodal model.

11. The method according to claim 10, further comprising:
splitting the first sample data into multiple first data blocks;
splitting the second sample data into multiple second data blocks;
forming a first input sequence based on an un-masked portion of the first data blocks; and
forming a second input sequence based on an un-masked portion of the second data blocks, wherein
the encoding the at least the portion of the first sample data includes encoding the first input sequence to obtain the first sample data representation, and
the encoding the at least the portion of the second sample data includes encoding the second input sequence to obtain the second sample data representation.

12. The method according to claim 10, wherein the determining the second loss comprises:
constructing a first vector based on the alignment label of the first sample data and the second sample data;
constructing a second vector based on the one or more prediction weights and a difference between a value 1 and a weight value based on the one or more prediction weights; and
determining the second loss based on the first vector and the second vector.

13. The method according to claim 10, wherein
the hybrid sample data representation includes a first hybrid sample representation biased toward the first modality and a second hybrid sample representation biased toward the second modality,
the one or more prediction weights include a first prediction weight determined based on the first hybrid sample representation and a second prediction weight determined based on the second hybrid sample representation,
the fusing the first sample data representation and the hybrid sample data representation includes fusing the first sample data representation and the first hybrid sample representation based on the first prediction weight, and
the fusing the second sample data representation and the hybrid sample data representation includes fusing the second sample data representation and the second hybrid sample representation based on the second prediction weight.

14. The method according to claim 10, further comprising:
determining a correlation between the first sample data and the second sample data based on the first sample data representation and the second sample data representation; and
determining a third loss based on the alignment label of the first sample data and the second sample data and the correlation between the first sample data and the second sample data,
wherein the constructing the target loss function is based on the first loss, the second loss, and the third loss.

15. The method according to claim 14, wherein
the correlation between the first sample data and the second sample data includes a first correlation of the first sample data with respect to the second sample data and a second correlation of the second sample data with respect to the first sample data, and
the determining the correlation between the first sample data and the second sample data includes:
determining a preset quantity of pieces of third sample data of the first modality, and a preset quantity of pieces of fourth sample data of the second modality;
calculating the first correlation based on the first sample data representation, the second sample data representation, and sample data representations of the fourth sample data; and
calculating the second correlation based on the first sample data representation, the second sample data representation, and sample data representations of the third sample data.

16. The method according to claim 15, wherein the calculating the first correlation comprises:
determining a first value based on the first sample data representation and the second sample data representation;
determining multiple second values based on the first sample data representation and the sample data representations of the fourth sample data; and
using a comparison value between the first value and a sum of the second values as the first correlation of the first sample data with respect to the second sample data.

17. The method according to claim 10, wherein
the first modality corresponds to an image modality,
the second modality corresponds to a text modality, and
the method further includes:
extracting image data in a text retrieval task;
forming first data pairs based on text data in a text library and the image data;
for each first data pair of the first data pairs,
processing the respective first data pair through the trained multimodal model to obtain two feature representations, and
determining a respective matching degree of the respective first data pair based on the two feature representations; and
determining, based on the matching degrees of the first data pairs, target text matching the image data.

18. The method according to claim 10, wherein
the first modality corresponds to an image modality,
the second modality corresponds to a text modality, and
the method further comprises:
extracting text data in an image retrieval task;
forming second data pairs using image data in an image library and the text data;
for each second data pair of the second data pairs,
processing the respective second data pair through the trained multimodal model to obtain two feature representations, and
determining a respective matching degree of the respective second data pair based on the two feature representations; and
determining, based on the matching degrees of the second data pairs, a target image matching the text data.

19. A data matching apparatus, comprising:
processing circuitry configured to:
encode first data of a first modality to obtain a first data representation;
encode second data of a second modality to obtain a second data representation, the first modality and the second modality corresponding to different modalities;
combine the first data representation and the second data representation to obtain a hybrid data representation;
determine one or more fusion weights based on the hybrid data representation;
fuse the first data representation and the hybrid data representation based on the one or more fusion weights to obtain a first fused representation;
fuse the second data representation and the hybrid data representation based on the one or more fusion weights to obtain a second fused representation; and
determine a matching degree between the first data and the second data based on the first fused representation and the second fused representation.

20. The apparatus according to claim 19, wherein the processing circuitry is configured to:
perform multiple interactive fusions based on the first data representation and the second data representation to obtain a first hybrid representation biased toward the first modality and a second hybrid representation biased toward the second modality; and
combine the first hybrid representation and the second hybrid representation to obtain the hybrid data representation.
